(19) United States
(12) Patent Application Publication
(10) Pub. No.: US 2025/0292378 A1
(43) Pub. Date: Sep. 18, 2025

(54) GENERATING COMPOSITE IMAGES

(71) Applicant: QUALCOMM Incorporated, San Diego, CA (US)

(72) Inventors: Tauseef KAZI, San Diego, CA (US); Tanmay JAIN, Los Angeles, CA (US); Nitin BANDWAR, San Diego, CA (US); Xi ZHU, San Diego, CA (US); Narayana Karthik RAVIRALA, San Diego, CA (US); Satyajit GIRI, San Diego, CA (US)

(21) Appl. No.: 18/608,787

(22) Filed: Mar. 18, 2024

(51) Int. Cl. G06T 5/90; G06T 3/40; G06T 5/20; G06T 5/50; G06T 7/11; G06T 11/00; H04N 23/84

(52) U.S. Cl. CPC G06T 5/90; G06T 3/40; G06T 5/20; G06T 5/50; G06T 7/11; G06T 11/001; G06T 2207/10144; G06T 2207/20208; H04N 23/84

(57) ABSTRACT

Systems and techniques are described herein for generating image data. For instance, a method for generating image data is provided. The method may include obtaining a first image captured according to first image-capture settings; determining second image-capture settings related to the first image-capture settings; obtaining a second image captured according to the second image-capture settings; determining a mask indicative of pixels of the first image that are overexposed or underexposed; adjusting luma values of the pixels of the first image based on luma values of corresponding pixels of the second image; and adjusting chroma values of the pixels of the first image based on chroma values of the corresponding pixels of the second image.

### TECHNICAL FIELD

The present disclosure generally relates to generating composite images. For example, aspects of the present disclosure include systems and techniques for efficiently generating composite images.

### BACKGROUND

A camera can receive light and capture image frames, such as still images or video frames, using an image sensor. Cameras can be configured with a variety of image-capture settings and/or image-processing settings to alter the appearance of images captured thereby. Image-capture settings may be determined and applied before and/or while an image is captured, such as ISO, exposure time (also referred to as exposure, exposure duration, or shutter speed), aperture size, (also referred to as f/stop), focus, and gain (including analog and/or digital gain), among others. Moreover, image-processing settings can be configured for post-processing of an image, such as alterations to contrast, brightness, saturation, sharpness, levels, curves, and colors, among others. In some cases, a camera can capture multiple images of a scene using different image-capture settings and can combine the captured images into a single image frame.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for generating image data. According to at least one example, a method is provided for generating image data. The method includes: obtaining a first image captured according to first image-capture settings; determining second image-capture settings related to the first image-capture settings; obtaining a second image captured according to the second image-capture settings; determining a mask indicative of pixels of the first image that are overexposed or underexposed; adjusting luma values of the pixels of the first image based on luma values of corresponding pixels of the second image; and adjusting chroma values of the pixels of the first image based on chroma values of the corresponding pixels of the second image.

In another example, an apparatus for generating image data is provided that includes at least one memory and at least one processor (e.g., configured in circuitry) coupled to the at least one memory. The at least one processor configured to: obtain a first image captured according to first image-capture settings; determine second image-capture settings related to the first image-capture settings; obtain a second image captured according to the second image-capture settings; determine a mask indicative of pixels of the first image that are overexposed or underexposed; adjust luma values of the pixels of the first image based on luma values of corresponding pixels of the second image; and adjust chroma values of the pixels of the first image based on chroma values of the corresponding pixels of the second image.

In another example, a non-transitory computer-readable medium is provided that has stored thereon instructions that, when executed by one or more processors, cause the one or more processors to: obtain a first image captured according to first image-capture settings; determine second image-capture settings related to the first image-capture settings; obtain a second image captured according to the second image-capture settings; determine a mask indicative of pixels of the first image that are overexposed or underexposed; adjust luma values of the pixels of the first image based on luma values of corresponding pixels of the second image; and adjust chroma values of the pixels of the first image based on chroma values of the corresponding pixels of the second image.

In another example, an apparatus for generating image data is provided. The apparatus includes: means for obtaining a first image captured according to first image-capture settings; means for determining second image-capture settings related to the first image-capture settings; means for obtaining a second image captured according to the second image-capture settings; means for determining a mask indicative of pixels of the first image that are overexposed or underexposed; means for adjusting luma values of the pixels of the first image based on luma values of corresponding pixels of the second image; and means for adjusting chroma values of the pixels of the first image based on chroma values of the corresponding pixels of the second image.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a block diagram illustrating an example architecture of an image processing system, according to various aspects of the present disclosure;

FIG. 2 is a block diagram illustrating an example of data flow in a camera system, according to various aspects of the present disclosure;

FIG. 3 illustrates two images with different exposures used to create a composite image;

FIG. 4 is a block diagram illustrating an example system for generating composite image data, according to various aspects of the present disclosure;

FIG. 5 includes an example image, an example mask based on image, and an example masked image, according to various aspects of the present disclosure;

FIG. 6 is a block diagram illustrating an example system for generating a composite image, according to various aspects of the present disclosure;

FIG. 7 is a block diagram illustrating another example system for generating composite image data, according to various aspects of the present disclosure;

FIG. 8 is a block diagram illustrating yet another example system for generating composite image data, according to various aspects of the present disclosure;

FIG. 9A is a block diagram illustrating an example system for generating a texture image, according to various aspects of the present disclosure;

FIG. 9B is a block diagram illustrating another example system for generating a texture image, according to various aspects of the present disclosure;

FIG. 10A is a diagram illustrating an example of an image, shown with pixels at illustrative pixel locations;

FIG. 10B is a diagram illustrating an example of an image, shown with pixels that correspond to pixels of the image of FIG. 10A;

FIG. 11 is a flow diagram illustrating another example process, in accordance with aspects of the present disclosure;

FIG. 12 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

Electronic devices (e.g., mobile phones, wearable devices (e.g., smart watches, smart glasses, etc.), tablet computers, extended reality (XR) devices (e.g., virtual reality (VR) devices, augmented reality (AR) devices, mixed reality (MR) devices, and the like), connected devices, laptop computers, etc.) are increasingly equipped with cameras to capture image frames, such as still images and/or video frames, for consumption. For example, an electronic device can include a camera to allow the electronic device to capture a video or image of a scene, a person, an object, etc. Additionally, cameras themselves are used in a number of configurations (e.g., handheld digital cameras, digital single-lens-reflex (DSLR) cameras, worn camera (including body-mounted cameras and head-borne cameras), stationary cameras (e.g., for security and/or monitoring), vehicle-mounted cameras, etc.).

A camera can receive light and capture image frames (e.g., still images or video frames) using an image sensor (which may include an array of photosensors). In some examples, a camera may include one or more processors, such as image signal processors (ISPs), that can process one or more image frames captured by an image sensor. For example, a raw image frame captured by an image sensor can be processed by an image signal processor (ISP) of a camera to generate a final image. In some cases, a camera, or an electronic device implementing a camera, can further process a captured image or video for certain effects (e.g., compression, image enhancement, image restoration, scaling, framerate conversion, etc.) and/or certain applications such as computer vision, extended reality (e.g., augmented reality, virtual reality, and the like), object detection, image recognition (e.g., face recognition, object recognition, scene recognition, etc.), feature extraction, authentication, and automation, among others.

Cameras can be configured with a variety of image-capture settings and/or image-processing settings to alter the appearance of an image. Image-capture settings can be determined and applied before or while an image is captured, such as ISO, exposure time (also referred to as exposure, exposure duration, and/or shutter speed), aperture size (also referred to as f/stop), focus, and gain, among others. Image-processing settings can be configured for post-processing of an image, such as alterations to a contrast, brightness, saturation, sharpness, levels, curves, and colors, among others.

In photography, the term “exposure,” relating to an image captured by a camera, refers to the amount of light per unit area that reaches a photographic film, or in modern cameras, an electronic image sensor (e.g., including an array of photodiodes). The exposure is based on certain image-capture settings such as, for example, exposure time, and/or lens aperture, as well as the luminance of the scene being photographed. Because of the relationship between the amount of light that reaches an image sensor and the duration of time the image sensors is allowed to capture the light, in the present disclosure, the terms “exposure,” “exposure duration,” and “exposure time” may refer to a duration of time during which the electronic image sensor is exposed to light (e.g., while the electronic image sensor is capturing an image) and/or an amount of time during which light reaching an image sensor is recorded as a single image frame.

Many cameras are equipped with an automatic exposure or “auto exposure” mode, where the image-capture settings (e.g., exposure time, lens aperture, etc.) of the camera may be automatically adjusted to match, as closely as possible, the luminance of a scene or subject being photographed. In some cases, an automatic exposure control (AEC) engine can perform AEC to determine image-capture settings for an image sensor. An AEC engine may seek to limit a number of pixels in an image frame that are overexposed and a number of pixels in an image frame that are underexposed. For example, an AEC engine may examine a first image, and determine image-capture settings for a subsequent image based on the exposure of the first image. For example, when a camera is capturing video data, the AEC engine may examine each frame and determine image-capture settings for each frame based on the exposure of the preceding frames. As another example, a camera may capture test frames (which may be displayed, for example, as preview frames to a user as they are composing a shot), and the AEC engine may determine image-capture settings based on the exposure of test frames.

In addition to AEC, many cameras are equipped with an auto-focus mode and/or an auto-white balance (AWB) mode. The auto-focus mode may control a position of a lens of the camera to set a focal point when capturing an image. The AWB mode may adjust values of stored pixels such that pixels representing white objects in the scene are white in captured image. Cameras with AEC, auto-focus, and AWB capabilities may be referred to as 3A cameras.

In photography and videography, a technique called high dynamic range (HDR) allows the dynamic range of image frames captured by a camera to be increased beyond the native capability of the camera. In this context, the term “dynamic range” refers to the range of luminosity between the brightest area and the darkest area of the scene or image frame. For example, a high dynamic range means there is large variation in light levels within a scene or an image frame. HDR can involve capturing multiple image frames of a scene with different exposures and combining captured image frames into a single image frame. The combination of image frames with different exposures can result in an image with a dynamic range higher than that of each individual image frame captured and combined to form the HDR image frame. For example, the electronic device can create a high dynamic image frame by combining two or more image frames with different exposures into a single frame. HDR is a feature often used by electronic devices, such as smartphones and mobile devices, for various purposes. For example, in some cases, a smartphone can use HDR to achieve a better image quality or an image quality similar to the image quality achieved by a digital single-lens reflex (DSLR) camera.

In the present disclosure, the term “combine,” and like terms, with reference to images or image data, may refer to any suitable techniques for using information (e.g., pixels) from two or more images to generate an image (e.g., a “composite” image). For example, pixels from a first image and pixels from a second image may be combined to generate a composite image. In such cases some of the pixels of the composite image may be from the first image and others of the pixels of the composite image may be from the second image. In some cases, some of the pixels from the first image and the second image may be merged, fused, or blended. For example, color and/or intensity values for pixels of the composite image may be based on respective pixels from both the first image and the second image. For instance, a given pixel of the composite image may be based on an average, or a weighted average, between a corresponding pixel of the first image and a corresponding pixel of the second image (e.g., the corresponding pixels of the first image and the second image may be blended). As one example, a central region of a first image may be included in a composite image. Further, an outer region of a second of a second image may be included in the composite image. Pixels surrounding the central region in the composite image may be based on weighted averages between corresponding pixels of the first image and corresponding pixels of the second image. In other words, pixels of the first image surrounding the central region may be merged, fused, or blended with pixels of the second image inside the outer region.

In some cases, an imaging device can generate an HDR image by combining multiple images that captured with different image-capture settings. For instance, an imaging device can generate an HDR image by combining a short-exposure image captured with a short exposure time and a long-exposure image captured with a long exposure time that is longer than the short exposure time. As another example, the imaging device can create an HDR image using a short-exposure image, a medium exposure image (that is capture with a medium exposure time that is between the short exposure time and the long exposure time), and a long-exposure image.

Because short-exposure images are generally dark, they preserve the most detail in the highlights (bright areas) of a photographed scene. Medium-exposure images and the long-exposure images are generally brighter than short-exposure images, and may be overexposed (e.g., too bright to make out details) in the highlight portions (bright areas) of the scene. Because long-exposure images generally include bright portions, they may preserve detail in the shadows (dark areas) of a photographed scene. Medium-exposure images and the short-exposure images are generally darker than long-exposure images, and may be underexposed (e.g., too dark to make out details in) in the shadow portions (dark areas) of the scene, making their depictions of the shadows too dark to observe details. To generate an HDR image, the imaging device may, for example, use portions of the short-exposure image to depict highlights (bright areas) of the photographed scene, use portions of the long-exposure image depicting shadows (dark areas) of the scene, and use portions of the medium-exposure image depicting other areas (other than highlights and shadows) of a scene.

A camera may include an image-capture device (or portion) including one or more image sensors that may capture light and generate raw image frames based thereon. The camera may include in image-processing device (or portion) including one or more image signal processors (ISPs) that may process the raw image frames. The image-processing device (or portion) may include a frontend portion and a backend portion. The image-capture device (or portion) may stream raw image data to the frontend portion of the image-processing device (or portion). The frontend portion may perform one or more operations on the raw image data. For example, the frontend portion may perform one or more operations related to Bad Pixel Correction (BPC), lens correction, phase-detection pixel correction, demosaicing, lateral chromatic aberration correction, Bayer filtering, adaptive Bayer filtering, tone mapping, noise reduction, etc. The frontend portion may provide processed image frames to the backend portion, for example, by writing the processed image frames to a memory, such as a double data rate (DDR) synchronous dynamic random-access memory (SDRAM) or any other memory device. The backend portion can retrieve the processed image frames from the memory and further process the image frames. For example, the backend portion may perform one or more operations related to noise reduction, tone mapping, and/or motion stabilization, etc. on the processed image frames. In the case of HDR, the backend portion may combine multiple raw image frames to generate a single composite image frame.

The write and/or read operations used to create the HDR image can result in significant power, bandwidth, and/or time consumption. For example, generating an HDR image based on two image frames of a scene can increase (e.g., double) a required data throughput (e.g., between the frontend portion and the backend portion), as compared with generating a single non-HDR image. Such an increase in required data throughput can increase latency and power consumption of a device in generating HDR images. Further, an image-processing device processing two image frames of a scene, instead of a single image frame of the scene, can increase data processing, memory requirements, and/or power consumption of the camera. Such an increase in data processing, memory requirements, and/or power consumption can impact battery life of devices.

Systems, apparatuses, methods (also referred to as processes), and computer-readable media (collectively referred to herein as “systems and techniques”) are described herein for generating composite images. The systems and techniques described herein may conserve computational resources (e.g., power, bandwidth, and/or time consumption) by transferring less image data between the frontend portion and the backend portion.

For example, other HDR techniques may transfer all of a short-exposure image and all of a long-exposure image because pixels of the composite image may be equally likely to come from the short-exposure image or from the long-exposure image. In contrast, the systems and techniques may capture an anchor image according to 3A image-capture settings (e.g., including AEC, auto-focus, and/or AWB). The systems and techniques may also capture a non-anchor image using different image-capture settings. The systems and techniques may determine the different image-capture settings such that the non-anchor image is more exposed or less exposed than the anchor image. The pixels of the anchor image (having been captured according to 3A image-capture settings) may have a higher chance of being included in the composite image because the pixels of the anchor frame are more likely to be properly exposed than the pixels of the non-anchor frame. The systems and techniques may transfer the entirety anchor frame and a downscaled version of the non-anchor frame from the frontend portion to the backend portion. By transferring only a downscaled version of the non-anchor frame (rather than the entirety of the non-anchor frame, the systems and techniques may conserve computational resources.

In some aspects, the systems and techniques may downscale the non-anchor image according to a scaling factor (e.g., reducing a number of pixels in height and/or width dimensions of the non-anchor image). Additionally or alternatively, the systems and techniques may downscale the non-anchor image by determining a mask indicative of pixels of the anchor image that may be replaced (or blended) with pixels of the non-anchor image. Thereafter, the systems and techniques may downscale the non-anchor image based on the mask, for example, such that the downscaled image includes pixels corresponding to pixels of the anchor image that may be replaced or blended.

Additionally or alternatively, the systems and techniques may generate the composite image by determining how to adjust luma and chroma value of pixels independently. For example, the systems and techniques may first adjust a luma value of a given pixel and then determine whether and how to adjust a chroma value of the given pixel.

Various aspects of the application will be described with respect to the figures below.

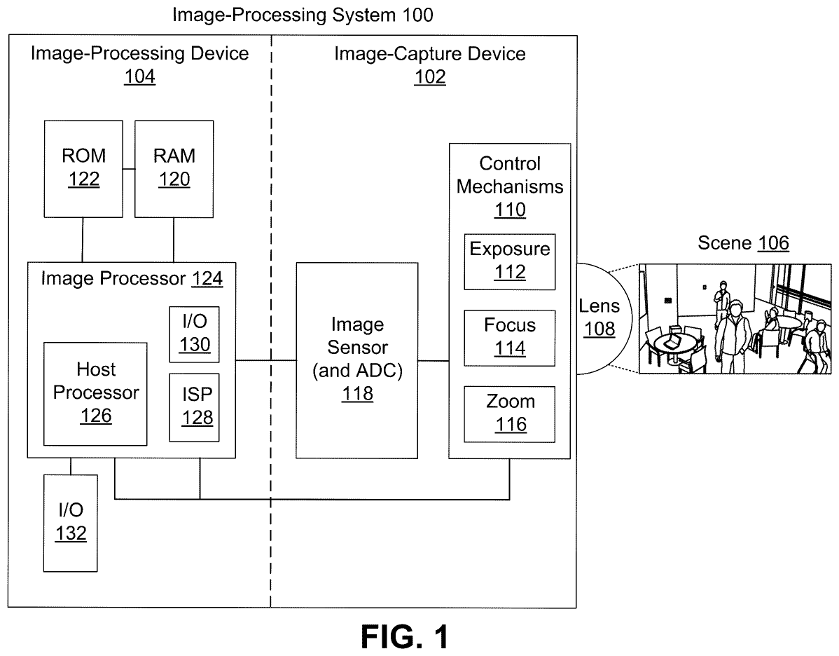

FIG. 1 is a block diagram illustrating an example architecture of an image-processing system 100, according to various aspects of the present disclosure. The image-processing system 100 includes various components that are used to capture and process images, such as an image of a scene 106. The image-processing system 100 can capture image frames (e.g., still images or video frames). In some cases, the lens 108 and image sensor 118 (which may include an analog-to-digital converter (ADC)) can be associated with an optical axis. In one illustrative example, the photosensitive area of the image sensor 118 (e.g., the photodiodes) and the lens 108 can both be centered on the optical axis.

In some examples, the lens 108 of the image-processing system 100 faces a scene 106 and receives light from the scene 106. The lens 108 bends incoming light from the scene toward the image sensor 118. The light received by the lens 108 then passes through an aperture of the image-processing system 100. In some cases, the aperture (e.g., the aperture size) is controlled by one or more control mechanisms 110. In other cases, the aperture can have a fixed size.

The one or more control mechanisms 110 can control exposure, focus, and/or zoom based on information from the image sensor 118 and/or information from the image processor 124. In some cases, the one or more control mechanisms 110 can include multiple mechanisms and components. For example, the control mechanisms 110 can include one or more exposure-control mechanisms 112, one or more focus-control mechanisms 114, and/or one or more zoom-control mechanisms 116. The one or more control mechanisms 110 may also include additional control mechanisms besides those illustrated in FIG. 1. For example, in some cases, the one or more control mechanisms 110 can include control mechanisms for controlling analog gain, flash, HDR, depth of field, and/or other image capture properties.

The focus-control mechanism 114 of the control mechanisms 110 can obtain a focus setting. In some examples, focus-control mechanism 114 stores the focus setting in a memory register. Based on the focus setting, the focus-control mechanism 114 can adjust the position of the lens 108 relative to the position of the image sensor 118. For example, based on the focus setting, the focus-control mechanism 114 can move the lens 108 closer to the image sensor 118 or farther from the image sensor 118 by actuating a motor or servo (or other lens mechanism), thereby adjusting the focus. In some cases, additional lenses may be included in the image-processing system 100. For example, the image-processing system 100 can include one or more microlenses over each photodiode of the image sensor 118. The microlenses can each bend the light received from the lens 108 toward the corresponding photodiode before the light reaches the photodiode.

In some examples, the focus setting may be determined via contrast detection autofocus (CDAF), phase detection autofocus (PDAF), hybrid autofocus (HAF), or some combination thereof. The focus setting may be determined using the control mechanism 110, the image sensor 118, and/or the image processor 124. The focus setting may be referred to as an image capture setting and/or an image processing setting. In some cases, the lens 108 can be fixed relative to the image sensor and the focus-control mechanism 114.

The exposure-control mechanism 112 of the control mechanisms 110 can obtain an exposure setting. In some cases, the exposure-control mechanism 112 stores the exposure setting in a memory register. Based on the exposure setting, the exposure-control mechanism 112 can control a size of the aperture (e.g., aperture size or f/stop), a duration of time for which the aperture is open (e.g., exposure time or shutter speed), a duration of time for which the sensor collects light (e.g., exposure time or electronic shutter speed), a sensitivity of the image sensor 118 (e.g., ISO speed or film speed), analog gain applied by the image sensor 118, or any combination thereof. The exposure setting may be referred to as an image capture setting and/or an image processing setting.

The zoom-control mechanism 116 of the control mechanisms 110 can obtain a zoom setting. In some examples, the zoom-control mechanism 116 stores the zoom setting in a memory register. Based on the zoom setting, the zoom-control mechanism 116 can control a focal length of an assembly of lens elements (lens assembly) that includes the lens 108 and one or more additional lenses. For example, the zoom-control mechanism 116 can control the focal length of the lens assembly by actuating one or more motors or servos (or other lens mechanism) to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 108 in some cases) that receives the light from the scene 106 first, with the light then passing through a focal zoom system between the focusing lens (e.g., lens 108) and the image sensor 118 before the light reaches the image sensor 118. The focal zoom system may, in some cases, include two positive (e.g., converging, convex) lenses of equal or similar focal length (e.g., within a threshold difference of one another) with a negative (e.g., diverging, concave) lens between them. In some cases, the zoom-control mechanism 116 moves one or more of the lenses in the focal zoom system, such as the negative lens and one or both of the positive lenses. In some cases, zoom-control mechanism 116 can control the zoom by capturing an image from an image sensor of a plurality of image sensors (e.g., including image sensor 118) with a zoom corresponding to the zoom setting. For example, the image-processing system 100 can include a wide-angle image sensor with a relatively low zoom and a telephoto image sensor with a greater zoom. In some cases, based on the selected zoom setting, the zoom-control mechanism 116 can capture images from a corresponding sensor.

The image sensor 118 includes one or more arrays of photodiodes or other photosensitive elements. Each photodiode measures an amount of light that eventually corresponds to a particular pixel in the image produced by the image sensor 118. In some cases, different photodiodes may be covered by different filters. In some cases, different photodiodes can be covered in color filters, and may thus measure light matching the color of the filter covering the photodiode. Various color filter arrays can be used such as, for example and without limitation, a Bayer color filter array, a quad color filter array (QCFA), and/or any other color filter array.

In some cases, the image sensor 118 may alternately or additionally include opaque and/or reflective masks that block light from reaching certain photodiodes, or portions of certain photodiodes, at certain times and/or from certain angles. In some cases, opaque and/or reflective masks may be used for phase detection autofocus (PDAF). In some cases, the opaque and/or reflective masks may be used to block portions of the electromagnetic spectrum from reaching the photodiodes of the image sensor (e.g., an infrared (IR) cut filter, an ultraviolet (UV) cut filter, a band-pass filter, low-pass filter, high-pass filter, or the like). The image sensor 118 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 110 may be included instead or additionally in the image sensor 118. The image sensor 118 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

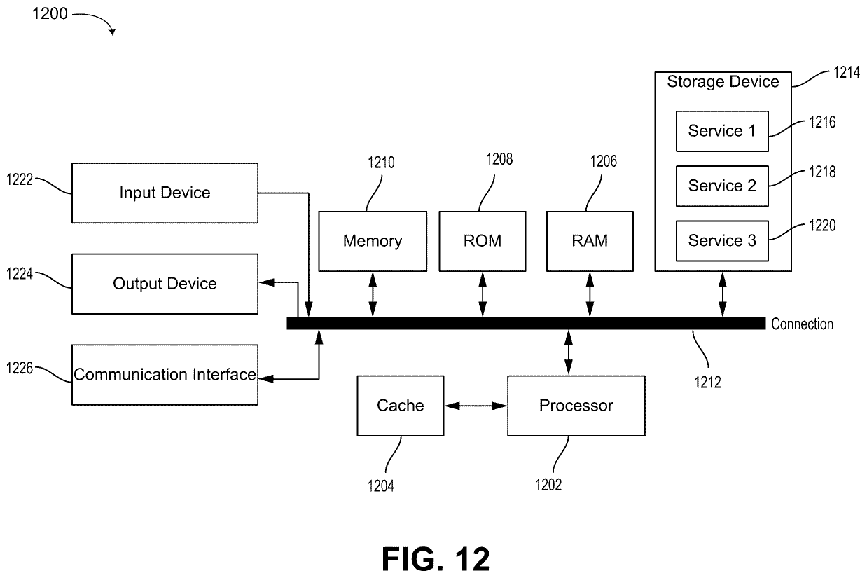

The image processor 124 may include one or more processors, such as one or more image signal processors (ISPs) (including ISP 128), one or more host processors (including host processor 126), and/or one or more of any other type of processor discussed with respect to the computing-device architecture 1200 of FIG. 12. The host processor 126 can be a digital signal processor (DSP) and/or other type of processor. In some implementations, the image processor 124 is a single integrated circuit or chip (e.g., referred to as a system-on-chip or SoC) that includes the host processor 126 and the ISP 128. In some cases, the chip can also include one or more input/output ports (e.g., input/output (I/O) ports 130), central processing units (CPUs), graphics processing units (GPUs), broadband modems (e.g., third generation (3G), fourth generation (4G) or long-term evolution (LTE), 5G, etc.), memory, connectivity components (e.g., Bluetooth™, Global Positioning System (GPS), etc.), any combination thereof, and/or other components. The I/O ports 130 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General-Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 126 can communicate with the image sensor 118 using an I2C port, and the ISP 128 can communicate with the image sensor 118 using an MIPI port.

The image processor 124 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 124 may store image frames and/or processed images in random-access memory (RAM) 120, read-only memory (ROM) 122, a cache, a memory unit, another storage device, or some combination thereof.

Various input/output (I/O) devices 132 may be connected to the image processor 124. The I/O devices 132 can include a display screen, a keyboard, a keypad, a touchscreen, a trackpad, a touch-sensitive surface, a printer, any other output devices, any other input devices, or any combination thereof. In some cases, a caption may be input into the image-processing device 104 through a physical keyboard or keypad of the I/O devices 132, or through a virtual keyboard or keypad of a touchscreen of the I/O devices 132. The I/O devices 132 may include one or more ports, jacks, or other connectors that enable a wired connection between the image-processing system 100 and one or more peripheral devices, over which the image-processing system 100 may receive data from the one or more peripheral device and/or transmit data to the one or more peripheral devices. The I/O devices 132 may include one or more wireless transceivers that enable a wireless connection between the image-processing system 100 and one or more peripheral devices, over which the image-processing system 100 may receive data from the one or more peripheral device and/or transmit data to the one or more peripheral devices. The peripheral devices may include any of the previously-discussed types of the I/O devices 132 and may themselves be considered I/O devices 132 once they are coupled to the ports, jacks, wireless transceivers, or other wired and/or wireless connectors.

In some cases, the image-processing system 100 may be a single device. In some cases, the image-processing system 100 may be two or more separate devices, including an image-capture device 102 (e.g., a camera) and an image-processing device 104 (e.g., a computing device coupled to the camera). In some implementations, the image-capture device 102 and the image-capture device 102 may be coupled together, for example via one or more wires, cables, or other electrical connectors, and/or wirelessly via one or more wireless transceivers. In some implementations, the image-capture device 102 and the image-processing device 104 may be disconnected from one another.

As shown in FIG. 1, a vertical dashed line divides the image-processing system 100 of FIG. 1 into two portions that represent the image-capture device 102 and the image-processing device 104, respectively. The image-capture device 102 includes the lens 108, control mechanisms 110, and the image sensor 118. The image-processing device 104 includes the image processor 124 (including the ISP 128 and the host processor 126), the RAM 120, the ROM 122, and the I/O device 132. In some cases, certain components illustrated in the image-capture device 102, such as the ISP 128 and/or the host processor 126, may be included in the image-capture device 102. In some examples, the image-processing system 100 can include one or more wireless transceivers for wireless communications, such as cellular network communications, 802.11 wi-fi communications, wireless local area network (WLAN) communications, or some combination thereof.

The image-processing system 100 can be part of, or implemented by, a single computing device or multiple computing devices. In some examples, the image-processing system 100 can be part of an electronic device (or devices) such as a camera system (e.g., a digital camera, an IP camera, a video camera, a security camera, etc.), a telephone system (e.g., a smartphone, a cellular telephone, a conferencing system, etc.), a laptop or notebook computer, a tablet computer, a set-top box, a smart television, a display device, a game console, an XR device (e.g., a head-mounted device (HMD), smart glasses, etc.), an IoT (Internet-of-Things) device, a smart wearable device, a video streaming device, an Internet Protocol (IP) camera, or any other suitable electronic device(s).

While the image-processing system 100 is shown to include certain components, one of ordinary skill will appreciate that the image-processing system 100 can include more components than those shown in FIG. 1. The components of the image-processing system 100 can include software, hardware, or one or more combinations of software and hardware. For example, in some implementations, the components of the image-processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image-processing system 100.

In some examples, the computing-device architecture 1200 shown in FIG. 12 and further described below can include the image-processing system 100, the image-capture device 102, the image-processing device 104, or a combination thereof.

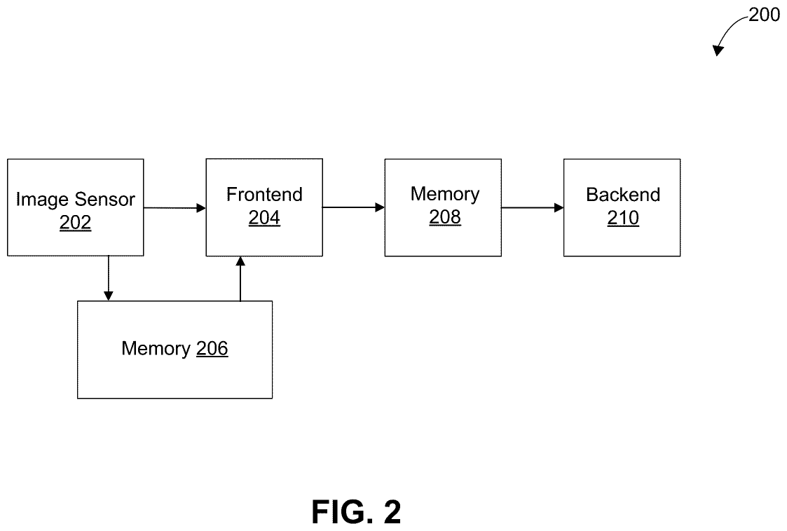

FIG. 2 is a block diagram illustrating an example of data flow in a camera system (e.g., image-processing system 100 of FIG. 1), according to various aspects of the present disclosure. System 200 includes an image sensor 202 (e.g., a camera sensor subsystem for obtaining image frames capturing scenes), a frontend 204 (e.g., an inline image processor, which may be referred to as an image front end (IFE) or thin front end (TFE)), and a backend 210 (e.g., an offline image processor which may be referred to as an offline processing engine or image processing engine (IPE)). Image sensor 202 may be an example of one or more elements of image-capture device 102 of FIG. 1, including, for example, lens 108, control mechanism 110, exposure-control mechanism 112, focus-control mechanism 114, zoom-control mechanism 116, and/or image sensor 118. Frontend 204 and backend 210 may both be implemented in image processor 124 of FIG. 1.

During operation image sensor 202 may provide image data (e.g., as a stream pixels) to frontend 204. In some cases, image sensor 202 may provide image data to frontend 204 via a Mobile Industry Processor Interface (MIPI). In such cases, the processing by frontend 204 may be referred to as inline processing because frontend 204 may process the pixels in line with the operation of the image sensor 202 (e.g., as the pixels are received from image sensor 202 via the MIPI). In other cases, system 200 may include a memory 206 and image sensor 202 may write image data (e.g., a stream of pixels) to memory 206 and frontend 204 may read the image data (e.g., the stream of pixels) from memory 206. In any case, after frontend 204 receives the pixels from image sensor 202, frontend 204 can process the pixels (e.g., by processing the pixels one line at a time). Frontend 204 may perform one or more operations related to, for example, Bad Pixel Correction (BPC), lens correction, phase-detection pixel correction, demosaicing, lateral chromatic aberration correction, Bayer filtering, adaptive Bayer filtering, tone mapping, noise reduction, etc. After frontend 204 has processed one or more of the lines of the image frame, the frontend 204 can transfer the processed sensor data to memory 208.

Backend 210 can read the image frames from memory 208. Memory 208 may be, or may include, a double data rate (DDR) synchronous dynamic random-access memory (SDRAM) or any other memory device. Backend 210 may retrieve the processed image frames from memory 208 and further process the image frames. For example, backend 210 may perform one or more operations related to noise reduction, tone mapping, and/or motion stabilization, etc. on the processed image frames. In cases in which system 200 performs high dynamic resolution (HDR), backend 210 may combine multiple raw image frames to generate a single composite image frame.

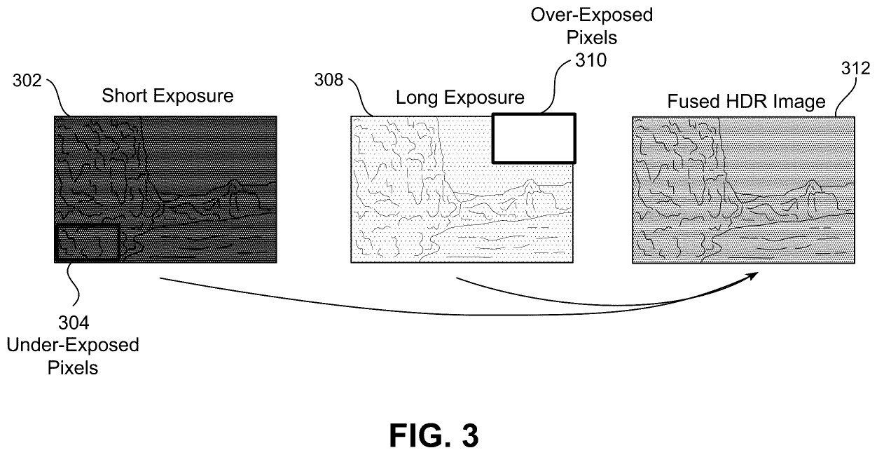

When creating an HDR image, over-exposed pixels of a long-exposure image and under-exposed pixels of a short-exposure image generally do not contribute to the final HDR image. For example, FIG. 3 illustrates multiple images with different exposures used to create a composite image (e.g., HDR image 312). In particular, FIG. 3 shows a short-exposure image 302, a long-exposure image 308, and HDR image 312 generated by combining pixels from short-exposure image 302 and long-exposure image 308. Short-exposure image 302 includes under-exposed pixels 304, and the long-exposure image 308 includes over-exposed pixels 310. As shown in FIG. 3, under-exposed pixels 304 of short-exposure image 302 and over-exposed pixels 310 of the long-exposure image 308 do not contribute to the pixels of the HDR image 312.

Nevertheless, when creating HDR image 312, an image-processing system may write under-exposed pixels 304 of short-exposure image 302 and over-exposed pixels 310 of long-exposure image 308 from a camera frontend to a memory device, reads them back from the memory device, and processes them to create the HDR image 312. For example, referring to FIG. 2, image sensor 202 may generate all of short-exposure image 302 (including under-exposed pixels 304 and/or long-exposure image 308 (including over-exposed pixels 310), and provide all of short-exposure image 302 and/or long-exposure image 308 to frontend 204. Frontend 204 may in turn write all of short-exposure image 302 and/or long-exposure image 308 to memory 208. Backend 210 may in turn read and process all of short-exposure image 302 and/or long-exposure image 308 from memory 208. The operations to read, write, and process the under-exposed pixels 304 of short-exposure image 302 and over-exposed pixels 310 of long-exposure image 308 contribute to the overall power and bandwidth consumption of an image-processing system when creating the HDR image 312, even though under-exposed pixels 304 and long-exposure image 308 do not contribute to the HDR image 312.

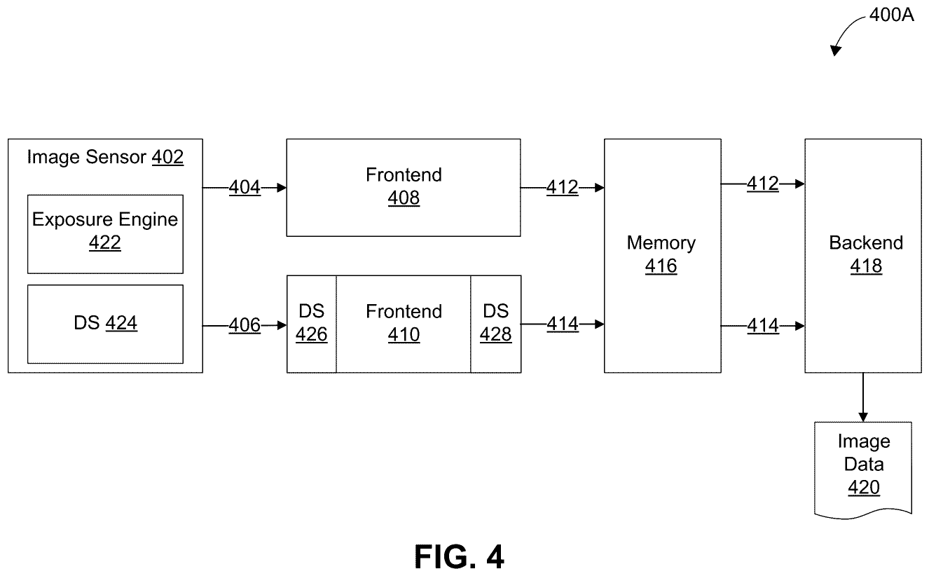

FIG. 4 is a block diagram illustrating an example system 400A for generating composite image data, according to various aspects of the present disclosure. System 400A includes an image sensor 402, a frontend 408, a frontend 410, a memory 416, and a backend 418. In general, image sensor 402 may generate image data 404 and image data 406, frontend 408 may process image data 404 to generate image data 412 (which may be a processed instance of image data 404), frontend 410 may process image data 406 to generate image data 414 (which may be a processed instance of image data 406), frontend 408 may store image data 412 and image data 414 in memory 416, backend 418 may read image data 412 and image data 414 from memory 416, and backend 418 may generate image data 420 based on image data 412 and image data 414.

In some aspects, image sensor 402 may be an example of one or more elements of image-capture device 102 of FIG. 1, including, for example, one or more of lens 108, control mechanism 110, exposure-control mechanism 112, focus-control mechanism 114, zoom-control mechanism 116, and/or image sensor 118 (as an example of image sensor 402). Image sensor 402 may generate image data 404 according to first image-capture settings and image data 406 according to second image-capture settings. For example, image sensor 402 may generate image data 404 to have a first exposure (e.g., based on capturing image sensor 402 using a first exposure duration, aperture, and/or ISO) and generate image data 406 to have a second exposure (e.g., based on capturing image sensor 402 using a second exposure duration, aperture, and/or ISO).

Some HDR techniques may select image-capture settings for image frames such that one of the two captured image frames is a short-exposure image (e.g., short-exposure image 302 of FIG. 3) and the other is a long-exposure image (e.g., long-exposure image 308 of FIG. 3) captured with a longer exposure than the short-exposure image. In contrast, according to various aspects of the present disclosure, system 400A may determine image-capture settings for capturing image data 404 according to automatic exposure control (AEC), auto-focus, and/or auto-white balance (AWB).

For example, image sensor 402 may include an exposure engine 422. Image sensor 402 may capture image data 404 using image-capture settings generated by an exposure engine 422 according to an AEC technique, an auto-focus technique, and/or a AWB technique. For example, exposure engine 422 may set the image-capture settings to match, as closely as possible, the luminance of a scene and/or a subject being photographed. Exposure engine 422 may seek to limit a number of pixels in image data 404 that are overexposed and a number of pixels in image data 404 that are underexposed. For example, prior to capturing image data 404, image sensor 402 may capture an image (or gather light information regarding a scene) and examine the image (or light information) to determine image-capture settings for capturing image data 404. For example, when image sensor 402 is capturing video data, exposure engine 422 may process or examine each frame and determine image-capture settings for each subsequent frame based on the exposure of a preceding frame (or frames) captured prior to a frame currently being processed or examined. As another example, image sensor 402 may capture test frames, which may be displayed, for example, as preview frames to a user as they are composing a shot. Exposure engine 422 may determine image-capture settings based on the exposure of the test frames.

Additionally or alternatively, exposure engine 422 may determine image-capture settings for capturing image data 406. For example, exposure engine 422 may determine the image-capture settings for capturing image data 406 to be different than the image-capture settings for capturing image data 404. In some cases, exposure engine 422 may determine the image-capture settings for capturing image data 406 based on image data 404 and/or the image-capture settings for image data 404. For example, exposure engine 422 may capture image data 404 and examine image data 404, for instance, to determine whether image data 404 includes under-exposed pixels or over-exposed pixels. If exposure engine 422 determines that image data 404 includes under-exposed pixels, exposure engine 422 may set the image-capture settings for image data 406 to increase an exposure of image data 406. Alternatively, if image data 404 includes over-exposed pixels, exposure engine 422 may set the image-capture settings for image data 406 to decrease an exposure of image data 406.

In some cases, exposure engine 422 may determine whether to increase or decrease an exposure of image data 406 based on whether image data 404 includes more under-exposed pixels or more over-exposed pixels. For example, if image data 404 includes more under-exposed pixels than over-exposed pixels, exposure engine 422 may set the image-capture settings for capturing image data 406 such that image data 406 is more exposed than image data 404. Alternatively, if image data 404 includes more over-exposed pixels than under-exposed pixels, exposure engine 422 may set the image-capture settings for capturing image data 406 such that image data 406 is less exposed than image data 404.

In some aspects, exposure engine 422 may determine the image-capture settings for capturing image data 406 based on a previously-capture image (or previously-capture light information). For example, apart from capturing image data 404, image sensor 402 may capture another image (e.g., another frame of video data or a test or preview image). Exposure engine 422 may examine the other image, for instance, to determine whether the other image includes under-exposed pixels or over-exposed pixels. If exposure engine 422 determines that the other image includes under-exposed pixels, exposure engine 422 may set the image-capture settings for image data 406 to increase an exposure of image data 406. Alternatively, if the other image includes over-exposed pixels, exposure engine 422 may set the image-capture settings for image data 406 to decrease an exposure of image data 406. In some cases, exposure engine 422 may determine whether to increase or decrease an exposure of image data 406 based on whether the other image includes more under-exposed pixels or more over-exposed pixels.

In some cases, when image data 404 represents a scene with moving objects, regardless of the other scene characteristics (e.g., brightness of the scene), exposure engine 422 of image sensor 402 may cause image data 404 to be underexposed to avoid motion artifacts. Exposure engine 422 may determine a longer exposure for image data 406 to capture details in portions of image data 406 that do not represent moving objects.

Frontend 408 may process image data 404 to generate image data 412 and frontend 410 may process image data 406 to generate image data 414. Frontend 408 and frontend 410 may be separate modules or frontend 408 and frontend 410 may be the same module and may process image data 404 and image data 406 at separate times or in parallel. Frontend 408 and frontend 410 may perform one or more operations related to, for example, Bad Pixel Correction (BPC), lens correction, phase-detection pixel correction, demosaicing, lateral chromatic aberration correction, Bayer filtering, adaptive Bayer filtering, tone mapping, noise reduction, etc. After frontend 408 has processed one or more of the lines of image data 404 to generate one or more corresponding lines of image data 412, frontend 408 may write the one or more lines of image data 412 to memory 416. Similarly, after frontend 410 has processed one or more of the lines of image data 406 to generate one or more corresponding lines of image data 414, frontend 410 may write the one or more lines of image data 414 to memory 416.

Backend 418 may read image data 412 and image data 414 from memory 416 and generate image data 420 based on image data 412 and image data 414. For example, image data 420 may be a composite image including some pixels from image data 412, some pixels from image data 414, and/or some pixels that are blended based on corresponding pixels of image data 412 and image data 414. Additionally, backend 418 may perform one or more operations related to noise reduction, tone mapping, and/or motion stabilization, etc. on image data 412, image data 414, and/or image data 420.

Other HDR techniques may capture a short-exposure image (which may include many under-exposed pixels) and a long-exposure image (which may include many over-exposed pixels). In contrast, system 400A may capture image data 404 according to AEC image-capture setting, auto-focus image-capture settings, and/or AWB image-capture settings such that image data 404 includes fewer under-exposed pixels than a short-exposure image of another HDR technique and fewer over-exposed pixels than a long-exposure image of the other HDR technique. Thus, image data 404 may include more pixels that will be included in image data 420 than pixels of a short-exposure image or pixels of a long-exposure image that will be included in an HDR image according to other HDR techniques. For example, more pixels of image data 404 may be included in image data 420 than pixels of short-exposure image 302 of FIG. 3 or over-exposed pixels 310 of FIG. 3 may be included in HDR image 312 of FIG. 3.

Because of the number of pixels of image data 404 that are included in image data 420, image data 420 may include relatively few of image data 406. For example, image data 420 may include fewer pixels from image data 406 than pixels of a short-exposure image or pixels of a long-exposure image that will be included in an HDR image according to other HDR techniques. For example, fewer pixels of image data 406 may be included in image data 420 than pixels of short-exposure image 302 of FIG. 3 or over-exposed pixels 310 of FIG. 3 may be included in HDR image 312 of FIG. 3.

Because image data 420 includes fewer pixels of image data 406 than of image data 404, system 400A may conserve computational resources (including bandwidth between frontend 408 and frontend 410 and backend 418 and/or read and write time writing to memory 416 and reading from memory 416) by downscaling image data 414. For example, system 400A may conserve bandwidth by writing a downscaled version of image data 414 to memory 416 rather than writing full-scale version of image data 414 to memory 416. For example, if image data 406 has dimensions of H×W (where H is a number of pixels in a height dimension and W is a number of pixels in a width dimension), system 400A may conserve bandwidth by downscaling image data 414 to have dimensions of H/2×W/2. Such downscaling may conserve computational resources by writing 75% fewer pixels to memory 416.

In some aspects, system 400A may downscale image data 406 at image sensor 402, for example, as image data 406 is captured or before image data 406 is provided to frontend 410. For example, image sensor 402 may include a downscaler 424 that may reduce a scale of image data 406. Downscaling image data 406 at image sensor 402 may conserve computational resources at frontend 410, for example, by reducing an amount of data to be processed by frontend 410 and/or an amount of data transferred from image sensor 402 to frontend 410.

In some aspects, system 400A may downscale image data 406 early in the processing of frontend 410. For example, frontend 410 may include a downscaler 426 that may downscale image data 406 before frontend 410 begins processing image data 406 or early within the processing of image data 406 by frontend 410. Downscaling image data 406 early within frontend 410 may conserve computational resources at frontend 410, for example, by reducing an amount of data to be processed by frontend 410.

In some aspects, system 400A may downscale image data 414 before writing image data 414 to memory 416. For example, frontend 410 may include a downscaler 428 that may downscale image data 406 before frontend 410 writes image data 414 to memory 416. Downscaling image data 414 before writing image data 414 to memory 416 may conserve computational resources by reducing an amount of data that is written to memory 416 and read from memory 416.

In some aspects, system 400A may downscale image data 414 when image data 414 is read from memory 416. For example, backend 418 may read a downscaled version of image data 414 from memory 416.

System 400A may downscale image data 406 (and/or image data 414) according to a scaling factor, for example, reducing a number of pixels of image data 406 (and/or of image data 414) by reducing pixel dimensions of image data 406 (or image data 414). Additionally or alternatively, system 400A may downscale image data 406 (or image data 414) according to a mask. For example, system 400A may generate a mask based on image data 404 that indicates which of image data 406 may be used in generating image data 420. For example, frontend 408 may analyze image data 404 and determine which of image data 404 are satisfy a criteria (e.g., not over-exposed and not under-exposed). Frontend 408 may generate a mask indicative of which pixels of image data 404 are bad (e.g., are under-exposed or are over-exposed). The mask may indicate which pixels of image data 406 may be used by backend 418 to generate image data 420 (either by replacing the bad pixels of image data 412 or by blending the pixels of image data 414 with the bad pixels of image data 412).

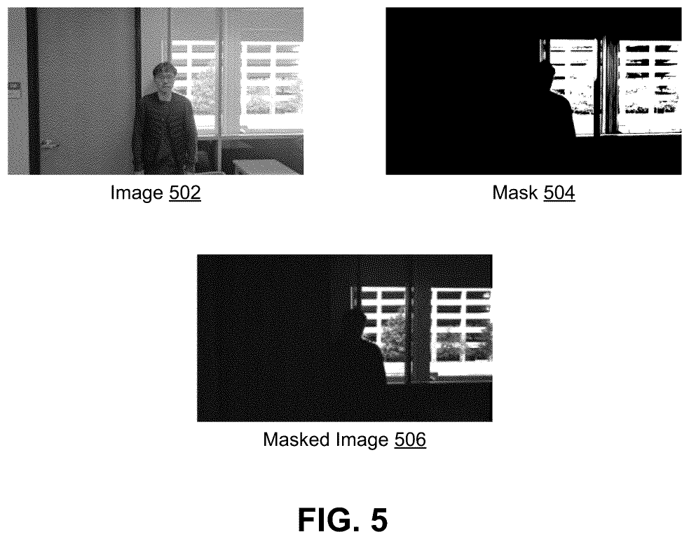

FIG. 5 includes an example image 502, an example mask 504 based on image 502, and an example masked image 506, according to various aspects of the present disclosure. For example, image 502 may be an example of image data 404 of FIG. 4. Mask 504 may be a mask indicative of which pixels of image 502 satisfy a criteria. For example, pixels that appear black in mask 504 may be indicative of pixels that are not overexposed in image 502; such pixels may be used in image data 420. Pixels that appear white in mask 504 may be indicative of bad pixels in image 502 (e.g., overexposed pixels in image 502); bad pixels may not be used in image data 420.

Masked image 506 may be an example of pixels of image data 406 of FIG. 4 with mask 504 applied to image data 406. For example, masked image 506 may include the pixels of image data 406 as masked by mask 504. For instance, masked image 506 may include colored pixel values of image data 406 where mask 504 includes white pixels. Masked image 506 may not include pixel values where mask 504 includes black pixels.

Returning to FIG. 4, system 400A may downscale image data 406 based on the mask. For example, using downscaler 426, frontend 410 may downscale image data 406 to process the pixels indicated by the mask as being pixels that may be used to generate image data 420 (e.g., and to not process pixels that may not be used to generate image data 420). For example, downscaler 426 may process the colored pixel values of masked image 506 and not the black pixels of masked image 506. Additionally or alternatively, at downscaler 428, whether frontend 410 processed all of image data 406 or not, frontend 410 may write pixels that may be used to generate image data 420 to memory 416 (e.g., and not pixels that may not be used to generate image data 420). For example, downscaler 428 may write the colored pixel values of masked image 506 to memory 416 and not write the black pixels of masked image 506 to memory 416.

By downscaling image data 406 and/or image data 414 (either by a scale factor or masking), system 400A may reduce an amount of data processed at frontend 410, written to memory 416, and/or read from memory 416. Thus, by downscaling image data 406 and/or image data 414, system 400A may conserve computational resources (including processing time and power at frontend 410 and/or backend 418, write time and bandwidth between frontend 410 and memory 416, and/or read time between memory 416 and backend 418.

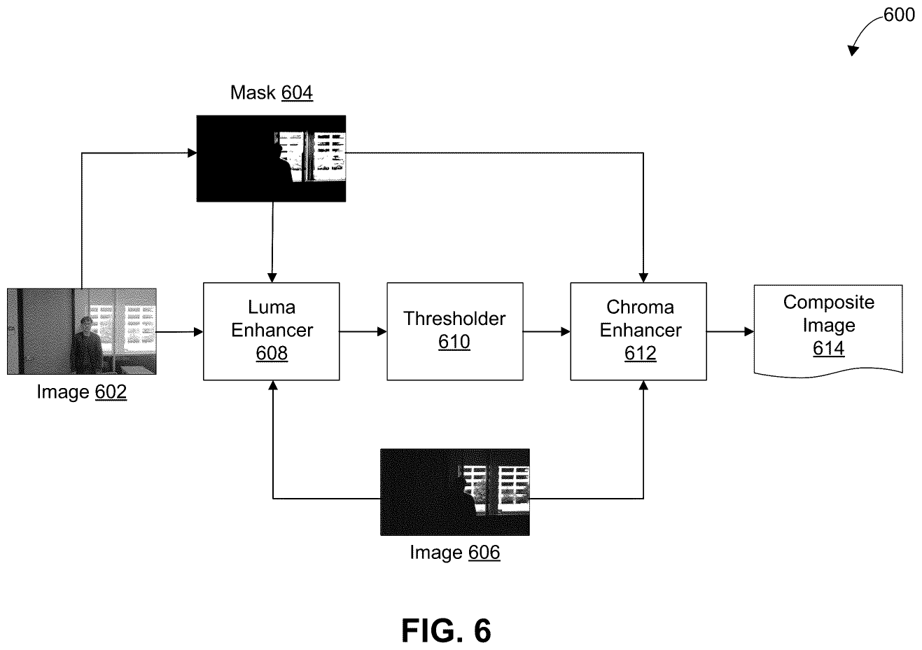

FIG. 6 is a block diagram illustrating an example system 600 for generating a composite image 614, according to various aspects of the present disclosure. System 600 may generate composite image 614 based on image 602 and image 606. For example, system 600 may combine pixels of image 602 and pixels of image 606 to generate composite image 614. For example, system 600 may select some pixels of image 602 to include in composite image 614, select some pixels of image 606 to include in composite image 614 and/or generate some pixel values for composite image 614 based on pixel values of image 602 and corresponding pixel values of image 606.

Image 602 may be an example of image sensor 402 of FIG. 4 and/or image 502 of FIG. 5. Image 602 may be captured according to automatic exposure control (AEC) image-capture settings, auto-focus image-capture settings, and/or auto-white balance (AWB) image-capture settings. For example, image 602 may have been captured to minimize a number of under-exposed pixels and over-exposed pixels in image 602.

Mask 604 may be a mask indicative of bad pixels of image 602. Mask 604 may be an example of mask 504 of FIG. 5. For example, mask 604 may indicate which pixels of image 602 are overexposed (or underexposed). In some aspects, mask 604 may be generated by a frontend (e.g., frontend 408 of FIG. 4). Additionally or alternatively, mask 604 may be generated by a backend (e.g., backend 418).

Image 606 may be an example of pixels of another image. Image 606 may represent the same scene as the scene represented by image 602. Image 606 may be an example of pixels of image data 406 of FIG. 4. In some aspects, image 606 may be a full-scale image (e.g., not downscaled and not masked). In other aspects, image 606 may be downscaled (e.g., according to a scaling factor and/or masked, such as by mask 604). For example, image 606 may be an example of masked image 506 of FIG. 5. Image 606 is illustrated in FIG. 6 as being a masked version of image data, for example, masked by mask 604.

Luma enhancer 608 may enhance luma values of pixels of image 602. For example, luma enhancer 608 may alter the luma values for bad pixels of image 602 based on mask 604 (e.g., mask 604 may indicate the bad pixels of image 602). Luma enhancer 608 may alter the luma values of image 602 based on the luma values of corresponding pixels of image 606. For example, for a given pixel, if mask 604 is black (e.g., indicating that the given pixel is not bad), luma enhancer 608 may retain the luma value of the given pixel. As another example, for another pixel, if mask 604 is white (e.g., indicating that the other pixel is bad), luma enhancer 608 may alter the luma value based on the luma value of a corresponding pixel of image 606. For example, luma enhancer 608 may replace the luma value of the other pixel with the luma value of the corresponding pixel of image 606. As another example, luma enhancer 608 may blend the luma value of the other pixel with the luma value of the corresponding pixel of image 606. In this way, luma values for overexposed pixels of image 602 will be reduced and luma values for underexposed pixels will be increased.

The pixel values of any or all of image 602 and image 606 (and other images of the present disclosure) may be according to any suitable format, including, as examples luma, (Y), and chroma (UV)—YUV and red-green-blue (RGB). When image 602 is represented by YUV values, luma enhancer 608 may directly adjust the Y—luma values. When image 602 is represented by another format (e.g., RGB), luma enhancer 608 may adjust the RGB values according to an RGB-to-luma translation.

Thresholder 610 may determine whether to adjust chroma values of pixel values of image 602 based on a threshold. Chroma enhancer 612 may implement adjusting the chroma values of pixels of image 602 based on determinations made by thresholder 610. Thresholder 610 may determine for which pixels of image 602 to adjust chroma values based on a ratio between pixel color values.

For example, for each pixel of image 602 (or, for each bad pixel of image 602, as indicated by mask 604), thresholder 610 may determine a saturation weight and a corresponding saturation weight of a corresponding pixel of image 606. A saturation weight of a given pixel may be defined by a relationship (e.g., ratio) between pixel color values of the given pixel.

For example, a given pixel of image 602 may have pixel color values of red 100, green 100, and blue 110 [100, 100, 110]. The saturation weight (SW) of the given pixel may be defined by a ratio between a difference between the highest of the pixel color values (PC_{H}) and the lowest of the pixel color values (PC_{L}) to the highest of the pixel color values (PC_{H}), such as SW=(PC_{H}−PC_{L})/PC_{H}, which in this case would be (110−100)/110, which computes to 0.091. If a saturation weight of a pixel is relatively low (e.g, below 0.3), the pixel may appear washed out. For example, the color of the pixel may appear to be black, gray, or white, (e.g., based on having nearly the same values of red, green, and blue).

A corresponding pixel of image 606 may have pixel color values of red 20, green 100, and blue 30 [20, 100, 30]. The saturation weight of the given pixel may be (100−20)/100, which computes to 0.800. If the saturation weight of a pixel is relatively high (e.g., above 0.6), the pixel may appear vibrant. For example, the color of the pixel may have a color other than white, gray, or black.

Thresholder 610 may determine how to determine the chroma of the given pixel in composite image 614 based on a relationship (e.g., ratio) between the saturation weight the given pixel of image 602 and the saturation weight of the given pixel of image 606. For example, based saturation weight the given pixel of image 602 divided by the saturation weight of the given pixel of image 606, for example, 0.091/0.800, which computes to 0.114. The ratio between the saturation weight the given pixel of image 602 and the saturation weight of the given pixel of image 606 may be referred to as a saturation ratio. Thresholder 610 may compare the saturation ratio of the given pixel to a saturation threshold and determine whether chroma values of image 606 for composite image 614 based on whether the saturation ratio exceed the saturation threshold. For example, the saturation threshold may be 0.10. Because the saturation ratio of the given pixel is 0.114, which exceeds the saturation threshold of 0.10, thresholder 610 may determine that chroma enhancer 612 takes chroma values for the given pixel of composite image 614 from image 606 rather than from image 602. Additionally or alternatively, thresholder 610 may determine that chroma enhancer 612 blend chroma values between image 602 and image 606 based on the saturation ratio being between two thresholds.

Other HDR techniques may determine whether to replace or blend pixels as a whole. system 600 evaluates and alters luma and chroma values separately. Thus, according to various aspects of the present disclosure, system 600 may adjust a luma value of a given pixel without adjusting the chroma value of the pixel. The appearance of images adjusted according to various aspects of the present disclosure may be more aesthetically pleasing than the appearance of images adjusted according to other HDR techniques.

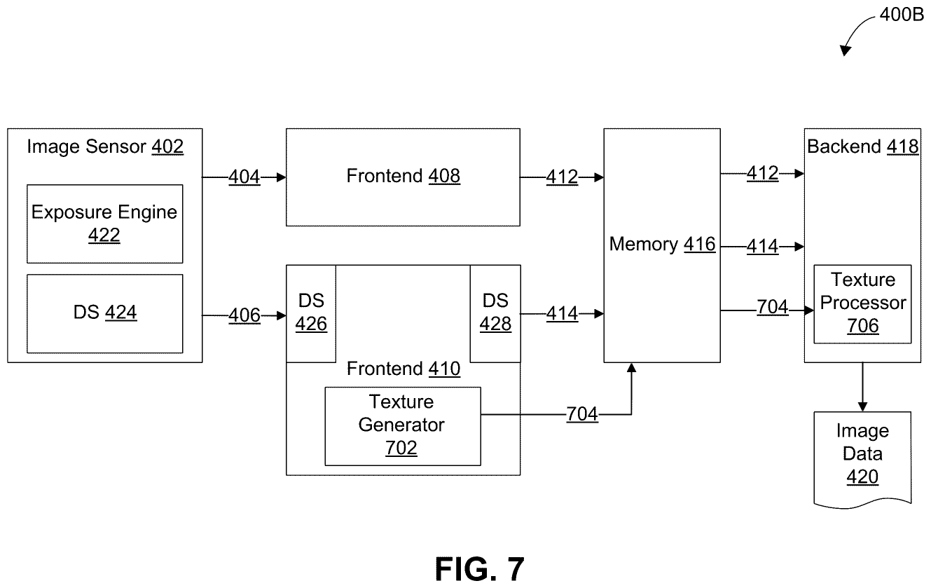

FIG. 7 is a block diagram illustrating an example system 400B for generating composite image data, according to various aspects of the present disclosure. System 400B may be an alternative to system 400A and may provide some improvements compared to system 400A.

For example, in some aspects, system 400A may downscale image data 406 (e.g., at any of downscaler 424, downscaler 426, and/or downscaler 428), to generate image data 414. System 400A may write image data 414 to memory 416, then read image data 414 from memory 416 at backend 418. At backend 418, system 400A may upscale image data 414 before using image data 414 to generate image data 420 based on image data 412 and image data 414 (e.g., as described with regard to system 600 of FIG. 6). Because image data 414 is downscaled, image data 414 may include less information than image data 406. For example, even after upscaling image data 414, image data 414 may have lost texture information in the downscaling. For example, the downscaling and upscaling may, in effect, high-pass filter image data 406.

System 400B may preserve the texture information by generating texture image 704 at texture generator 702 (based on image data 406) and passing texture image 704 to backend 418. Texture image 704 may be according to any suitable format, including, as examples luma, (Y), and chroma (UV)—YUV and red-green-blue (RGB). At backend 418, texture processor 706 may restore the texture information, for example, by upscaling image data 414 and combining texture image 704 with image data 404. After combining texture image 704 with image data 414, backend 418 may generate image data 420 based on image data 412 and the combined image data 414 and texture image 704 (e.g., as described with regard to system 600 of FIG. 6).

In this way, system 400B may get the benefit of downscaling image data 406 before writing image data 414 to memory (thus conserving bandwidth). Further, system 400B may mitigate the loss of information (e.g., the loss of high-frequency texture information) by preserving the information in texture image 704 and restoring the information at texture processor 706.

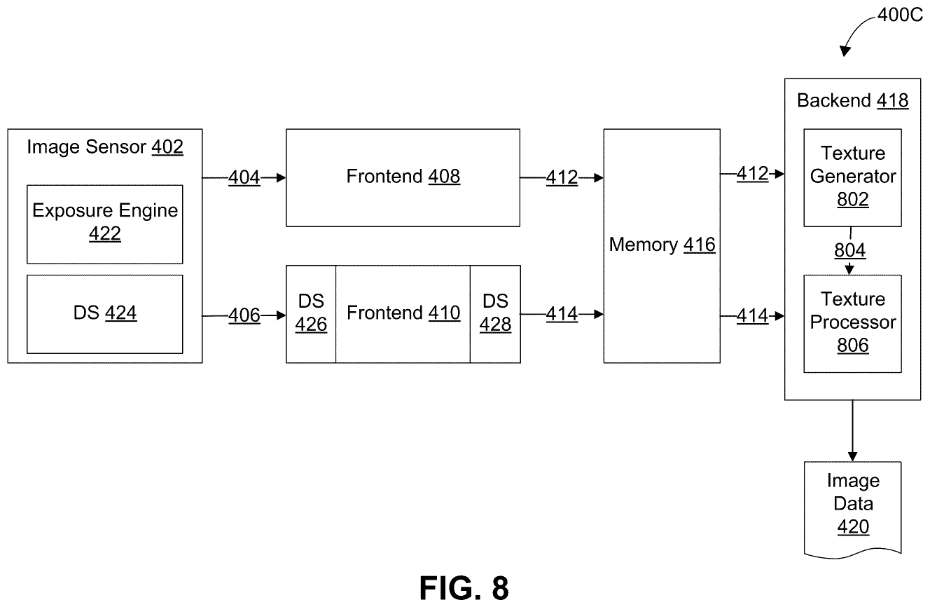

FIG. 8 is a block diagram illustrating an example system 400C for generating composite image data, according to various aspects of the present disclosure. System 400C may be an alternative to system 400A and to system 400B. System 400C may provide at least the advantages provided system 400B. System 400C may provide additional advantages.

For example, rather than generating texture image 704 based on image data 406, texture generator 802 may generate texture image 804 based on image data 412. Then, texture processor 806 may add information (e.g., texture information based on image data 412) to image data 414. For example, backend 418 may upscale image data 414 and texture processor 806 may add the texture information of image data 412, to the upscaled image data 414. After combining texture image 804 with image data 414, backend 418 may generate image data 420 based on image data 412 and the combined image data 414 and texture image 804 (e.g., as described with regard to system 600 of FIG. 6).

Image data 412 may not have been downscaled. Thus, image data 412 may not be subject to the information loss to which image data 414 was subject. Yet, image data 412 may be similar to image data 414 based on image data 404 and image data 406 representing the same scene (e.g., based on image data 404 and image data 406 being captured for the purpose of generating a composite image). Thus, the texture information of image data 412 may be similar to the texture information of image data 406 that may be lost when image data 406 is downscaled. Accordingly, texture processor 806 may add texture information (from image data 412) to image data 414 to improve image data 414.

System 400C may get the benefit of downscaling image data 406 before writing image data 414 to memory (thus conserving bandwidth). Further, system 400C may mitigate the loss of information (e.g., high-frequency texture information) by using the information of image data 412 to supplement image data 414. Further, system 400C may not store texture image 704 to memory and read texture image 704 from memory. Thus, compared to system 400B, system 400C may conserve bandwidth between frontend 408 and frontend 410 and backend 418. Further, in system 400C, because frontend 410 does not generate a texture image based on image data 406, downscaler 424 may downscale image data 406 before image data 406 is provided to frontend 410.

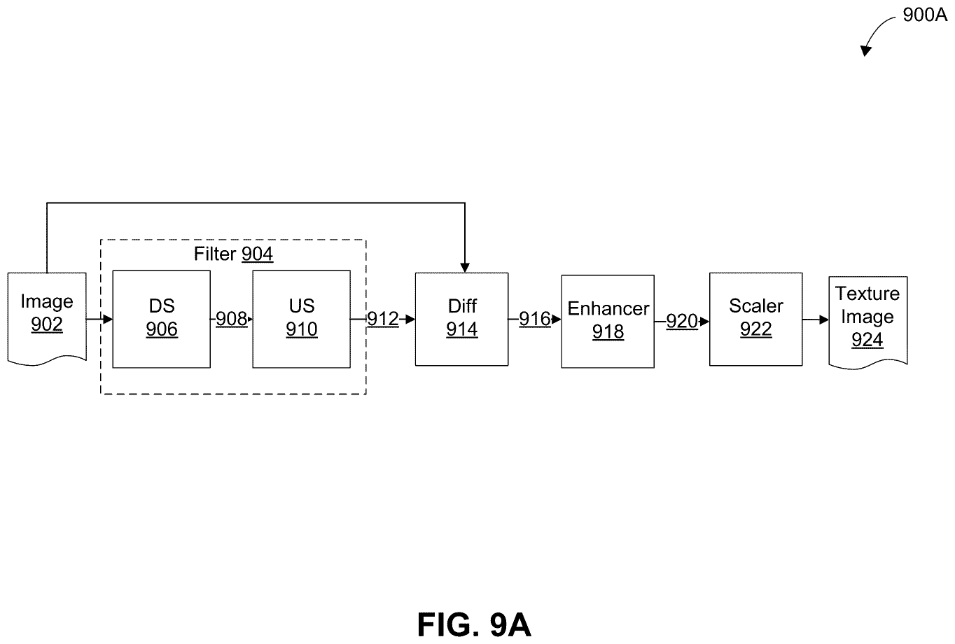

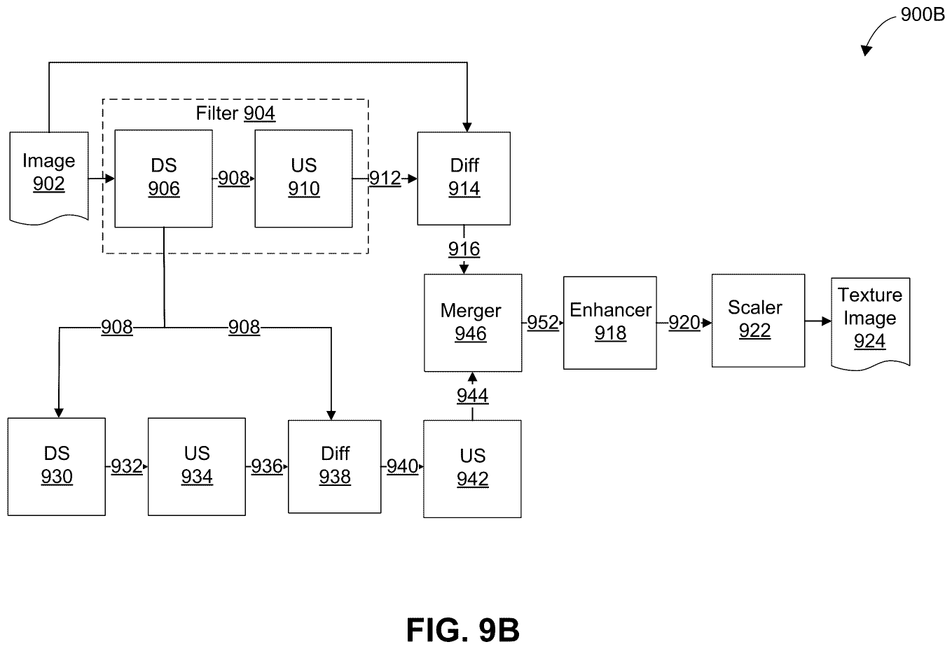

FIG. 9A is a block diagram illustrating an example system 900A for generating a texture image 924, according to various aspects of the present disclosure. System 900A may be an example of texture generator 702 of FIG. 7 and/or texture generator 802 of FIG. 8. As such, image 902 may be an example of image data 406 of FIG. 7 and/or image data 412 of FIG. 8 and texture image 924 may be an example of texture image 704 of FIG. 7 and/or texture image 804 of FIG. 8.

In general, system 900A may high-pass filter image 902 using filter 904, then compare the high-pass filtered instance of image 902 with image 902 using differencer 914 to determine comparison image 916. Comparison image 916 may include high-frequency information of image 902. In some aspects, system 900A may enhance comparison image 916 using enhancer 918 to generate enhanced image 920. Further, in some aspects, system 900A may scale enhanced image 920 using scaler 922 to generate texture image 924.

Image 902 may be any image. Image 902 may be an image of a pair which will be used to generate a composite image. Image 902 may be an example of image data 406 of FIG. 7 and/or image data 412 of FIG. 8. In some aspects, image 902 may be modified from being a color image (e.g., according to a RGB format or a YUV format) to a grayscale format.

Filter 904 may be a filter, for example, a high-pass filter. Filter 904 may include a downscaler 906 and an upscaler 910. Downscaler 906 may downscale image 902 by any scaling factor (e.g., 2) to generate downscaled image 908. Upscaler 910 may upscale downscaled image 908 by the same scaling factor (e.g., 2) to generate upscaled downscaled image 912. Upscaled downscaled image 912 may be a high-pass filtered instance of image 902.

Differencer 914 may compare image 902 and upscaled downscaled image 912 and generate comparison image 916 as a result. For example, differencer 914 may subtract upscaled downscaled image 912 from image 902 to generate comparison image 916. More specifically, differencer 914 may subtract a pixel value of upscaled downscaled image 912 from each corresponding pixel value of image 902. In some aspects, comparison image 916 may have positive and negative values. In some aspects, comparison image 916 may include two image files, one for positive values and one for negative values.

Enhancer 918 may enhance values of comparison image 916. In some aspects, enhancer 918 may enhance all values of comparison image 916. In some aspects, enhancer 918 may enhance values of overexposed portions of image 902 or underexposed portions of image 902. For example, enhancer 918 may use a mask that is the same as, or substantially similar to mask 604 of FIG. 6) to determine which values to enhance.

Scaler 922 may change the scale of enhanced image 920 to generate texture image 924. For example, scaler 922 may reduce the bit width of values of enhanced image 920. For instance, scaler 922 may right shift binary values of enhanced image 920. Scaler 922 may conserve computational resources by scaling enhanced image 920, for example, by reducing a size (in memory) of values of texture image 924.

FIG. 9B is a block diagram illustrating an example system 900B for generating a texture image 924, according to various aspects of the present disclosure. System 900B may be an alternative to system 900A and may provide some improvements compared to system 900A. System 900B may reduce noise of texture image 924 compared to system 900A. For example, in addition to the elements of system 900A, system 900B includes a downscaler 930, an upscaler 934, a differencer 938, an upscaler 942, and a merger 946.

Downscaler 930 may downscale downscaled image 908 (by a scaling factor, such as 2) to generate downscaled image 932. Upscaler 934 may upscale downscaled downscaled image 932 (by the scaling factor) to generate upscaled downscaled image 936. In effect, downscaler 930 and upscaler 934 may high-pass filter downscaled image 908.

Differencer 938 may compare downscaled image 908 and upscaled downscaled downscaled image 936 and generate comparison image 940 as a result. For example, differencer 938 may subtract upscaled downscaled image 936 from downscaled image 908 to generate comparison image 940. More specifically, differencer 938 subtract a pixel value of upscaled downscaled image 936 from each corresponding pixel value of downscaled image 908. In some aspects, comparison image 940 may have positive and negative values. In some aspects, comparison image 940 may include two image files, one for positive values and one for negative values.

Upscaler 942 may upscale comparison image 940 (by the same scaling factor used by downscaler 906) to generate upscaled comparison image 944. Merger 946 may combine comparison image 916 and upscaled comparison image 944 to generate combined image 952. Enhancer 918 may enhance combined image 952 to generate enhanced image 920 and scaler 922 may scale enhanced image 920 to generate texture image 924.

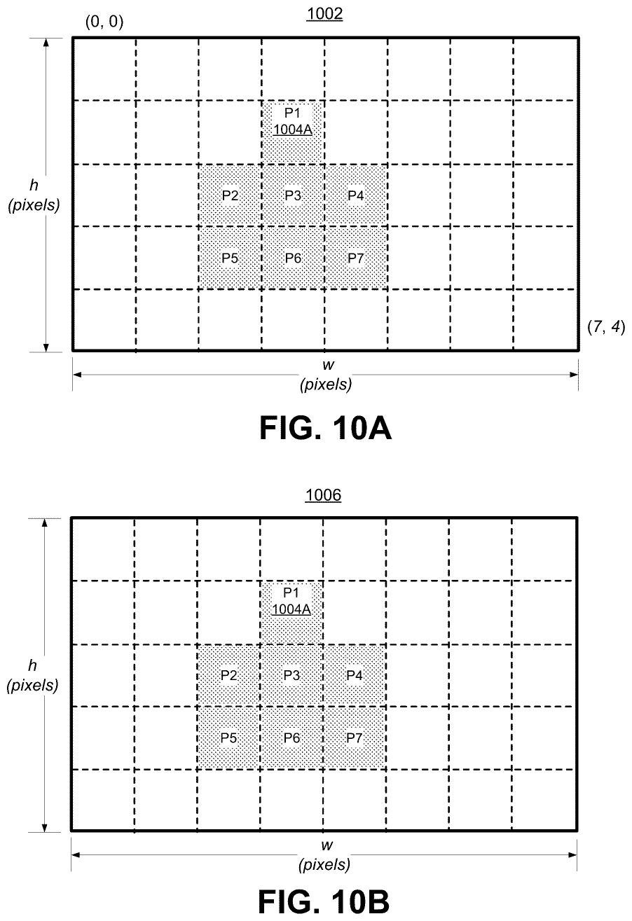

FIG. 10A is a diagram illustrating an example of an image 1002, shown with pixels P1, P2, P3, P4, P5, P6, and P7 (e.g., bad pixels, such as overexposed or underexposed pixels) at illustrative pixel locations. Image 1002 may be an example of image data 404 of FIG. 4 and/or of image 602 of FIG. 6. Image 1002 is shown with dimensions of w pixels wide by h pixels high (denoted as w×h). Image 1002 can include many more pixel locations than those illustrated in FIG. 10A. For example, image 1002 may include a 4K (or ultra-high definition (UHD)) frame at a resolution of 3,840×2,160 pixels, an HD frame at a resolution of 1,920×1,080 pixels, or any other suitable frame having another resolution. A pixel P1 is shown at a pixel location 1004A. The pixel location 1004A can include a (w, h) pixel location of (3, 1) relative to the top-left-most pixel location of (0, 0). The pixel P1 is used for illustrative purposes and can correspond to any suitable point on the object of interest, such as the point of a nose of a person.

FIG. 10B is a diagram illustrating an example of an image 1006, shown with pixels P1, P2, P3, P4, P5, P6, and P7 that correspond to pixels of image 1002. Image 1006 may be an example of image data 406 of FIG. 4. Pixels P1, P2, P3, P4, P5, P6, and P7 in image 1006 correspond to pixels P1, P2, P3, P4, P5, P6, and P7 in image 1002. As shown, the pixel P1 has the same location 1004A in image 1002 and image 1006.

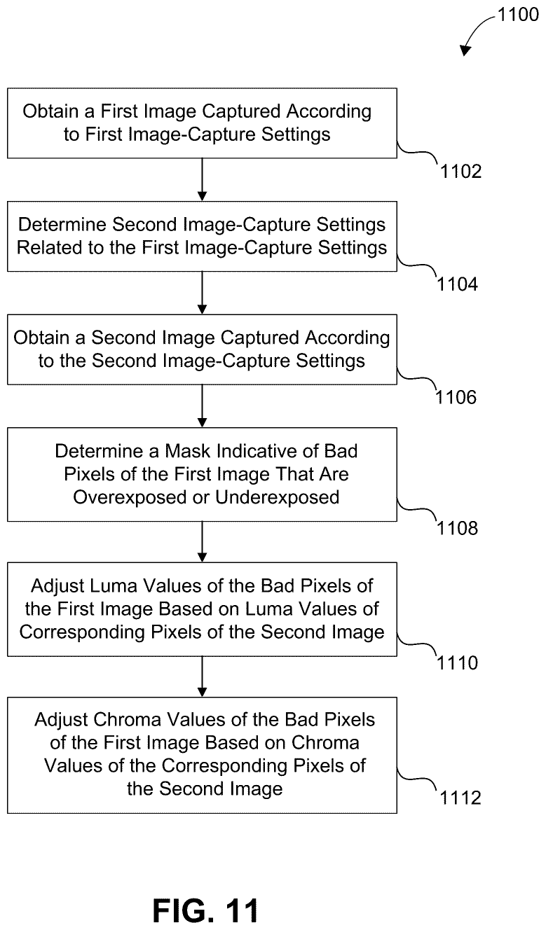

FIG. 11 is a flow diagram illustrating a process 1100 for generating composite images, in accordance with aspects of the present disclosure. One or more operations of process 1100 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the process 1100. The one or more operations of process 1100 may be implemented as software components that are executed and run on one or more processors.

At block 1102, a computing device (or one or more components thereof) may obtain a first image captured according to first image-capture settings. For example, system 400A of FIG. 4 may obtain image data 404 of FIG. 4. Image data 404 may be captured by image sensor 402 of FIG. 4 according to first image-capture settings (which may be determined, for example, by exposure engine 422 of FIG. 4).

In some aspects, the first image-capture settings may be, or may include, at least one of an auto-focus setting, an auto-exposure setting, or an auto-white-balance setting. For example, exposure engine 422 may determine an auto-focus setting, an auto-exposure setting, or an auto-white-balance setting

At block 1104, the computing device (or one or more components thereof) may determine second image-capture settings related to the first image-capture settings. For example, exposure engine 422 may determine second image-capture settings based on image data 404.

In some aspects, to determine the second image-capture settings, the computing device (or one or more components thereof) may obtain a third image captured prior to the first image; and determine the first image-capture settings and the second image-capture settings based on an exposure of the third image. For example, image sensor 402 of FIG. 4 may capture a third image (prior to capturing image data 404). Exposure engine 422 may determine the first image-capture settings and the second image-capture settings based on the third image.

At block 1106, the computing device (or one or more components thereof) may obtain a second image captured according to the second image-capture settings. For example, 400A may obtain image data 406 of FIG. 4. Image data 406 may be captured according to the second image-capture settings determined at block 1104.

In some aspects, to determine the second image-capture settings, the computing device (or one or more components thereof) may determine that the pixels of the first image are overexposed and determine the second image-capture settings to decrease an exposure of the second image. For example, exposure engine 422 may determine that at least some pixels of image data 404 are overexposed and determine the second image-capture settings to decrease the exposure of image data 406.

In some aspects, to determine the second image-capture settings, the computing device (or one or more components thereof) may determine that the pixels of the first image are underexposed and determine the second image-capture settings to increase an exposure of the second image. For example, exposure engine 422 may determine that at least some pixels of image data 404 are underexposed and determine the second image-capture settings to increase the exposure of image data 406.

In some aspects, the second image may have a lower resolution than the first image. In some aspects, the computing device (or one or more components thereof) may downscale the second image based on a scaling factor. For example, downscaler 424 of FIG. 4, downscaler 426 of FIG. 4, or downscaler 428 of FIG. 4 may downscale the second image. In some aspects, the computing device (or one or more components thereof) may downscale the second image based on the mask. For example, downscaler 424, downscaler 426, or downscaler 428 may downscale image data 406 (or a prior to image data 406) based on a mask, (e.g., mask 504 of FIG. 5).

At block 1108, the computing device (or one or more components thereof) may determine a mask indicative of pixels of the first image that are overexposed or underexposed. For example, system 400A may determine a mask (e.g., mask 504 of FIG. 5). The mask may indicate pixels of image data 404 that are either overexposed or underexposed.

In some aspects, the computing device (or one or more components thereof) may write the corresponding pixels of the second image to a memory based on the mask. For example, frontend 410 of FIG. 4 may write pixels of image data 406 to memory 416 of FIG. 4 based on the mask (e.g., mask 504).

At block 1110, the computing device (or one or more components thereof) may adjust luma values of the pixels of the first image based on luma values of corresponding pixels of the second image. For example, luma enhancer 608 of FIG. 6 may adjust luma values of pixels of image 602 based on luma values of corresponding pixels of image 606.

In some aspects, to adjust the luma values of the pixels of the first image, the computing device (or one or more components thereof) may replace the luma values of the pixels of the first image with the luma values of corresponding pixels of the second image. For example, luma enhancer 608 of FIG. 6 may replace luma values of overexposed pixel values (or underexposed values) of image 602 with luma values of corresponding pixel values of image 606.

In some aspects, to adjust the luma values of the pixels of the first image, the computing device (or one or more components thereof) may blend the luma values of the pixels of the first image with the luma values of corresponding pixels of the second image. For example, luma enhancer 608 of FIG. 6 may blend luma values of overexposed pixel values (or underexposed values) of image 602 with luma values of corresponding pixel values of image 606.

At block 1112, the computing device (or one or more components thereof) may adjust chroma values of the pixels of the first image based on chroma values of the corresponding pixels of the second image. For example, chroma enhancer 612 of FIG. 6 may adjust chroma values of pixels of image 602 based on chroma values of corresponding pixels of image 606.

In some aspects, the computing device (or one or more components thereof) may determine for which of the pixels of the first image to adjust the chroma values based on a comparison between a saturation of the pixels of the first image and a saturation of the corresponding pixels of the second image. For example, chroma enhancer 612 may compare a saturation of pixels of image 602 with a saturation of pixels of image 606 to determine which pixels of image 602 to adjust chroma values of.

In some aspects, to adjust the chroma values of the pixels of the first image, the computing device (or one or more components thereof) may replace the chroma values of the pixels of the first image with the chroma values of corresponding pixels of the second image. For example, chroma enhancer 612 may replace chroma values of overexposed pixel values (or underexposed values) of image 602 with chroma values of corresponding pixels of image 606.

In some aspects, to adjust the chroma values of the pixels of the first image, the computing device (or one or more components thereof) may blend the chroma values of the pixels of the first image with the chroma values of corresponding pixels of the second image. For example, chroma enhancer 612 may blend chroma values of overexposed pixel values (or underexposed values) of image 602 with chroma values of corresponding pixels of image 606.

In some aspects, the computing device (or one or more components thereof) may determine third image-capture settings related to the first image-capture settings and obtain a third image captured according to the third image-capture settings. At least some pixels of the second image may be underexposed and at least some pixels of the third image may be overexposed. To determine the mask, the computing device (or one or more components thereof) may determine underexposed pixels of the first image and determine overexposed pixels of the first image. To adjust the luma values of the pixels of the first image, the computing device (or one or more components thereof) may adjust the luma values of the overexposed pixels of the first image based on luma values of corresponding pixels of the second image. To adjust chroma values of the pixels of the first image, the computing device (or one or more components thereof) may adjust the chroma values of the overexposed pixels of the first image based on chroma values of the corresponding pixels of the second image. The computing device (or one or more components thereof) may adjust the luma values of the underexposed pixels of the first image based on luma values of corresponding pixels of the third image adjust the chroma values of the underexposed pixels of the first image based on chroma values of the corresponding pixels of the third image.

For example, exposure engine 422 may determine third image-capture settings based on image data 404 and/or based on the second image-capture settings. For example, exposure engine 422 may determine the second image-capture settings to include less exposure than the first image-capture settings and the third image-capture settings to include more exposure than the first image-capture settings. Image sensor 402 may obtain a third image (e.g., a second instance of image data 406) based on the third image-capture settings. The second image (e.g, the first instance of image data 406) may include at least some underexposed pixels. The third image (e.g., the second instance of image data 406) may include at least some overexposed pixels. 400A may determine a mask indicative of underexposed pixels and overexposed pixels of the first image. Luma enhancer 608 of FIG. 6 may adjust the luma values of the overexposed pixels of the first image based on the luma values of corresponding pixels of the second image. Luma enhancer 608 may adjust the luma values of the underexposed pixels of the first image based on the luma values of corresponding pixels of the third image. Chroma enhancer 612 of FIG. 6 may adjust the chroma values of the overexposed pixels of the first image based on the chroma values of corresponding pixels of the second image. Chroma enhancer 612 may adjust the chroma values of the underexposed pixels of the first image based on the chroma values of corresponding pixels of the third image.

In some aspects, the computing device (or one or more components thereof) may downscale the second image to generate a downscaled second image; write the downscaled second image to memory; read the downscaled second image from the memory; upscale the downscaled second image to generate a upscaled downscaled second image; generate a texture image; and modify the upscaled downscaled second image based on the texture image to generate a modified second image. The luma values of the pixels of the first image may be adjusted based on luma values of corresponding pixels of the modified second image. The chroma values of the pixels of the first image may be adjusted based on chroma values of the corresponding pixels of the modified second image. For example, downscaler 424, downscaler 426, or downscaler 428 may downscale the second image. Frontend 410 may write the downscaled second image to memory 416. Backend 418 may read the downscaled scaled second image from memory 416 and upscale the downscaled second image. Texture generator 702 of FIG. 7 may generate a texture image 704 or texture generator 802 of FIG. 8 may generate a texture image 804. Texture processor 706 of FIG. 7 may process texture image 704 and modify the second upscaled downscaled image to generate a modified second image or texture processor 806 of FIG. 8 may process texture image 804 and modify the second upscaled downscaled image to generate a modified second image. Luma enhancer 608 of FIG. 6 may adjust the luma values of the first image (e.g., image data 412) based on the modified second image. Additionally or alternatively, chroma enhancer 612 of FIG. 6 may adjust the chroma values of the first image (e.g., image data 412) based on the modified second image.

In some aspects, to generate the texture image, the computing device (or one or more components thereof) may high-pass filter the second image to generate a filtered second image and compare the filtered second image to the second image to generate the texture image. For example, system 900a of FIG. 9A may filter image 902 at filter 904 and compare upscaled downscaled image 912 to image 902.

In some aspects, to generate the texture image, the computing device (or one or more components thereof) may high-pass filter the second image to generate a filtered second image; compare the filtered second image to the second image to generate a comparison image; adjust comparison image; and adjust a bit width of binary values representative of the comparison image to generate the texture image. For example, system 900a of FIG. 9A may filter image 902 at filter 904 and compare upscaled downscaled image 912 to image 902 to generate comparison image 916. System 900a may further adjust comparison image 916 at enhancer 918 to generate enhanced image 920, and adjust a bit width of enhanced image 920 to generate texture image 924.

In some aspects, to generate the texture image, the computing device (or one or more components thereof) may downscale the second image to generate a downscaled second image; upscale the downscaled second image to generate an upscaled downscaled second image; compare the second image to the upscaled downscaled second image to generate a first comparison image; downscale the downscaled second image to generate a downscaled downscaled second image; upscale the downscaled second image to generate an upscaled downscaled second image; compare the downscaled second image to the upscaled downscaled second image to generate a second comparison image; upscale the second comparison image to generate an upscaled second comparison image; and combine the first comparison image and the upscaled second comparison image to generate the texture image. For example, system 900b of FIG. 9B may downscale the second image 902 to generate a downscaled second image 908; upscale the downscaled second image 908 to generate an upscaled downscaled second image 912; compare the second image 902 to the upscaled downscaled second image 912 to generate a first comparison image 916; downscale the downscaled second image 908 to generate a downscaled second image 932; upscale the downscaled second image 932 to generate an upscaled downscaled second image 936; compare the downscaled second image 908 to the upscaled downscaled downscaled second image 936 to generate a second comparison image 940; upscale the second comparison image 940 to generate an upscaled second comparison image 944; and combine the first comparison image 916 and the upscaled second comparison image 944 to generate the texture image 924.

In some aspects, to generate the texture image, the computing device (or one or more components thereof) may high-pass filter the first image to generate a filtered first image and compare the filtered first image to the first image to generate the texture image. For example, system 900a of FIG. 9A may filter image 902 at filter 904 and compare upscaled downscaled image 912 to image 902 to generate comparison image 916. System 900a may further adjust comparison image 916 at enhancer 918 to generate enhanced image 920, and adjust a bit width of enhanced image 920 to generate texture image 924.

In some examples, as noted previously, the methods described herein (e.g., process 1100 of FIG. 11, and/or other methods described herein) can be performed, in whole or in part, by a computing device or apparatus. In one example, one or more of the methods can be performed by system 400A of FIG. 4, system 400B, of FIG. 7, system 400C, of FIG. 8, system 600 of FIG. 6, or by another system or device. In another example, one or more of the methods (e.g., process 1100 of FIG. 11, and/or other methods described herein) can be performed, in whole or in part, by the computing-device architecture 1200 shown in FIG. 12. For instance, a computing device with the computing-device architecture 1200 shown in FIG. 12 can include, or be included in, the components of system 400A, system 400B, system 400C, and/or system 600 and can implement the operations of process 1100, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 1100, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 1100, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

FIG. 12 illustrates an example computing-device architecture 1200 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1200 may include, implement, or be included in any or all of system 400A of FIG. 4, system 400B, of FIG. 7, system 400C, of FIG. 8, system 900A of FIG. 9A, system 900B of FIG. 9B, and/or system 600 of FIG. 6. Additionally or alternatively, computing-device architecture 1200 may be configured to perform process 1100, and/or other process described herein.

The components of computing-device architecture 1200 are shown in electrical communication with each other using connection 1212, such as a bus. The example computing-device architecture 1200 includes a processing unit (CPU or processor) 1202 and computing device connection 1212 that couples various computing device components including computing device memory 1210, such as read only memory (ROM) 1208 and random-access memory (RAM) 1206, to processor 1202.

Computing-device architecture 1200 can include a cache of high-speed memory connected directly with, in close proximity to, or integrated as part of processor 1202. Computing-device architecture 1200 can copy data from memory 1210 and/or the storage device 1214 to cache 1204 for quick access by processor 1202. In this way, the cache can provide a performance boost that avoids processor 1202 delays while waiting for data. These and other modules can control or be configured to control processor 1202 to perform various actions. Other computing device memory 1210 may be available for use as well. Memory 1210 can include multiple different types of memory with different performance characteristics. Processor 1202 can include any general-purpose processor and a hardware or software service, such as service 1 1216, service 2 1218, and service 3 1220 stored in storage device 1214, configured to control processor 1202 as well as a special-purpose processor where software instructions are incorporated into the processor design. Processor 1202 may be a self-contained system, containing multiple cores or processors, a bus, memory controller, cache, etc. A multi-core processor may be symmetric or asymmetric.

To enable user interaction with the computing-device architecture 1200, input device 1222 can represent any number of input mechanisms, such as a microphone for speech, a touch-sensitive screen for gesture or graphical input, keyboard, mouse, motion input, speech and so forth. Output device 1224 can also be one or more of a number of output mechanisms known to those of skill in the art, such as a display, projector, television, speaker device, etc. In some instances, multimodal computing devices can enable a user to provide multiple types of input to communicate with computing-device architecture 1200. Communication interface 1226 can generally govern and manage the user input and computing device output. There is no restriction on operating on any particular hardware arrangement and therefore the basic features here may easily be substituted for improved hardware or firmware arrangements as they are developed.

Storage device 1214 is a non-volatile memory and can be a hard disk or other types of computer readable media which can store data that are accessible by a computer, such as magnetic cassettes, flash memory cards, solid state memory devices, digital versatile disks, cartridges, random-access memories (RAMs) 1206, read only memory (ROM) 1208, and hybrids thereof. Storage device 1214 can include services 1216, 1218, and 1220 for controlling processor 1202. Other hardware or software modules are contemplated. Storage device 1214 can be connected to the computing device connection 1212. In one aspect, a hardware module that performs a particular function can include the software component stored in a computer-readable medium in connection with the necessary hardware components, such as processor 1202, connection 1212, output device 1224, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“_”) and greater than or equal to (“>”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration). Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for generating image data, the apparatus comprising: at least one memory; and at least one processor coupled to the at least one memory and configured to: obtain a first image captured according to first image-capture settings; determine second image-capture settings related to the first image-capture settings; obtain a second image captured according to the second image-capture settings; determine a mask indicative of pixels of the first image that are overexposed or underexposed; adjust luma values of the pixels of the first image based on luma values of corresponding pixels of the second image; and adjust chroma values of the pixels of the first image based on chroma values of the corresponding pixels of the second image.

Aspect 2. The apparatus of aspect 1, wherein the first image-capture settings comprise at least one of an auto-focus setting, an auto-exposure setting, or an auto-white-balance setting.

Aspect 3. The apparatus of any one of aspects 1 or 2, wherein, to determine the second image-capture settings, the at least one processor is configured to determine that the pixels of the first image are overexposed and determine the second image-capture settings to decrease an exposure of the second image.

Aspect 4. The apparatus of any one of aspects 1 to 3, wherein, to determine the second image-capture settings, the at least one processor is configured to determine that the pixels of the first image are underexposed and determine the second image-capture settings to increase an exposure of the second image.

Aspect 5. The apparatus of any one of aspects 1 to 4, wherein, to determine the second image-capture settings, the at least one processor is configured to: obtain a third image captured prior to the first image; and determine the first image-capture settings and the second image-capture settings based on an exposure of the third image.

Aspect 6. The apparatus of any one of aspects 1 to 5, wherein the second image has a lower resolution than the first image.

Aspect 7. The apparatus of any one of aspects 1 to 6, wherein the at least one processor is configured to downscale the second image based on a scaling factor.

Aspect 8. The apparatus of any one of aspects 1 to 7, wherein the at least one processor is configured to downscale the second image based on the mask.

Aspect 9. The apparatus of any one of aspects 1 to 8, wherein the at least one processor is configured to write the corresponding pixels of the second image to a memory based on the mask.

Aspect 10. The apparatus of any one of aspects 1 to 9, wherein, to adjust the luma values of the pixels of the first image, the at least one processor is configured to replace the luma values of the pixels of the first image with the luma values of corresponding pixels of the second image.

Aspect 11. The apparatus of any one of aspects 1 to 10, wherein, to adjust the luma values of the pixels of the first image, the at least one processor is configured to blend the luma values of the pixels of the first image with the luma values of corresponding pixels of the second image.

Aspect 12. The apparatus of any one of aspects 1 to 11, wherein the at least one processor is configured to determine for which of the pixels of the first image to adjust the chroma values based on a comparison between a saturation of the pixels of the first image and a saturation of the corresponding pixels of the second image.

Aspect 13. The apparatus of any one of aspects 1 to 12, wherein, to adjust the chroma values of the pixels of the first image, the at least one processor is configured to replace the chroma values of the pixels of the first image with the chroma values of corresponding pixels of the second image.

Aspect 14. The apparatus of any one of aspects 1 to 13, wherein, to adjust the chroma values of the pixels of the first image, the at least one processor is configured to blend the chroma values of the pixels of the first image with the chroma values of corresponding pixels of the second image.

Aspect 15. The apparatus of any one of aspects 1 to 14, wherein the at least one processor is configured to: determine third image-capture settings related to the first image-capture settings; and obtain a third image captured according to the third image-capture settings; wherein: at least some pixels of the second image are underexposed; at least some pixels of the third image are overexposed; to determine the mask, the at least one processor is configured to determine underexposed pixels of the first image and determine overexposed pixels of the first image; to adjust the luma values of the pixels of the first image, the at least one processor is configured to adjust the luma values of the overexposed pixels of the first image based on luma values of corresponding pixels of the second image; and to adjust chroma values of the pixels of the first image, the at least one processor is configured to adjust the chroma values of the overexposed pixels of the first image based on chroma values of the corresponding pixels of the second image; wherein the at least one processor is configured to: adjust the luma values of the underexposed pixels of the first image based on luma values of corresponding pixels of the third image; and adjust the chroma values of the underexposed pixels of the first image based on chroma values of the corresponding pixels of the third image.

Aspect 16. The apparatus of any one of aspects 1 to 15, wherein the at least one processor is configured to: downscale the second image to generate a downscaled second image; write the downscaled second image to memory; read the downscaled second image from the memory; upscale the downscaled second image to generate a upscaled downscaled second image; generate a texture image; and modify the upscaled downscaled second image based on the texture image to generate a modified second image, wherein: the luma values of the pixels of the first image are adjusted based on luma values of corresponding pixels of the modified second image; and the chroma values of the pixels of the first image are adjusted based on chroma values of the corresponding pixels of the modified second image.

Aspect 17. The apparatus of aspect 16, wherein, to generate the texture image, the at least one processor is configured to: high-pass filter the second image to generate a filtered second image; and compare the filtered second image to the second image to generate the texture image.

Aspect 18. The apparatus of any one of aspects 16 or 17, wherein, to generate the texture image, the at least one processor is configured to: high-pass filter the second image to generate a filtered second image; compare the filtered second image to the second image to generate a comparison image; adjust comparison image; and adjust a bit width of binary values representative of the comparison image to generate the texture image.

Aspect 19. The apparatus of any one of aspects 16 to 18, wherein, to generate the texture image, the at least one processor is configured to: downscale the second image to generate a downscaled second image; upscale the downscaled second image to generate an upscaled downscaled second image; compare the second image to the upscaled downscaled second image to generate a first comparison image; downscale the downscaled second image to generate a downscaled second image; upscale the downscaled second image to generate an upscaled downscaled second image; compare the downscaled second image to the upscaled downscaled second image to generate a second comparison image; upscale the second comparison image to generate an upscaled second comparison image; and combine the first comparison image and the upscaled second comparison image to generate the texture image.

Aspect 20. The apparatus of any one of aspects 16 to 19, wherein, to generate the texture image, the at least one processor is configured to: high-pass filter the first image to generate a filtered first image; and compare the filtered first image to the first image to generate the texture image.

Aspect 21. A method for generating image data, the method comprising: obtaining a first image captured according to first image-capture settings; determining second image-capture settings related to the first image-capture settings; obtaining a second image captured according to the second image-capture settings; determining a mask indicative of pixels of the first image that are overexposed or underexposed; adjusting luma values of the pixels of the first image based on luma values of corresponding pixels of the second image; and adjusting chroma values of the pixels of the first image based on chroma values of the corresponding pixels of the second image.

Aspect 22. The method of aspect 21, wherein the first image-capture settings comprise at least one of an auto-focus setting, an auto-exposure setting, or an auto-white-balance setting.

Aspect 23. The method of any one of aspects 21 or 22, wherein determining the second image-capture settings comprises determining that the pixels of the first image are overexposed and determining the second image-capture settings to decrease an exposure of the second image.

Aspect 24. The method of any one of aspects 21 to 23, wherein determining the second image-capture settings comprises determining that the pixels of the first image are underexposed and determining the second image-capture settings to increase an exposure of the second image.

Aspect 25. The method of any one of aspects 21 to 24, wherein determining the second image-capture settings comprises: obtaining a third image captured prior to the first image; and determining the first image-capture settings and the second image-capture settings based on an exposure of the third image.

Aspect 26. The method of any one of aspects 21 to 25, wherein the second image has a lower resolution than the first image.

Aspect 27. The method of any one of aspects 21 to 26, further comprising downscaling the second image based on a scaling factor.

Aspect 28. The method of any one of aspects 21 to 27, further comprising downscaling the second image based on the mask.

Aspect 29. The method of any one of aspects 21 to 28, further comprising writing the corresponding pixels of the second image to a memory based on the mask.

Aspect 30. The method of any one of aspects 21 to 29, wherein adjusting the luma values of the pixels of the first image comprises replacing the luma values of the pixels of the first image with the luma values of corresponding pixels of the second image.

Aspect 31. The method of any one of aspects 21 to 30, wherein adjusting the luma values of the pixels of the first image comprises blending the luma values of the pixels of the first image with the luma values of corresponding pixels of the second image.

Aspect 32. The method of any one of aspects 21 to 31, further comprising determining for which of the pixels of the first image to adjust the chroma values based on a comparison between a saturation of the pixels of the first image and a saturation of the corresponding pixels of the second image.

Aspect 33. The method of any one of aspects 21 to 32, wherein adjusting the chroma values of the pixels of the first image comprises replacing the chroma values of the pixels of the first image with the chroma values of corresponding pixels of the second image.

Aspect 34. The method of any one of aspects 21 to 33, wherein adjusting the chroma values of the pixels of the first image comprises blending the chroma values of the pixels of the first image with the chroma values of corresponding pixels of the second image.

Aspect 35. The method of any one of aspects 21 to 34, further comprising: determining third image-capture settings related to the first image-capture settings; and obtaining a third image captured according to the third image-capture settings; wherein: at least some pixels of the second image are underexposed; at least some pixels of the third image are overexposed; determining the mask comprises determining underexposed pixels of the first image and determining overexposed pixels of the first image; adjusting the luma values of the pixels of the first image comprises adjusting the luma values of the overexposed pixels of the first image based on luma values of corresponding pixels of the second image; and adjusting chroma values of the pixels of the first image comprises adjusting the chroma values of the overexposed pixels of the first image based on chroma values of the corresponding pixels of the second image; further comprising: adjusting the luma values of the underexposed pixels of the first image based on luma values of corresponding pixels of the third image; and adjusting the chroma values of the underexposed pixels of the first image based on chroma values of the corresponding pixels of the third image.

Aspect 36. The method of any one of aspects 21 to 35, further comprising: downscaling the second image to generate a downscaled second image; writing the downscaled second image to memory; reading the downscaled second image from the memory; upscaling the downscaled second image to generate a upscaled downscaled second image; generating a texture image; and modifying the upscaled downscaled second image based on the texture image to generate a modified second image, wherein: the luma values of the pixels of the first image are adjusted based on luma values of corresponding pixels of the modified second image; and the chroma values of the pixels of the first image are adjusted based on chroma values of the corresponding pixels of the modified second image.

Aspect 37. The method of aspect 36, wherein generating the texture image comprises: high-pass filtering the second image to generate a filtered second image; and comparing the filtered second image to the second image to generate the texture image.

Aspect 38. The method of any one of aspects 36 or 37, wherein generating the texture image comprises: high-pass filtering the second image to generate a filtered second image; comparing the filtered second image to the second image to generate a comparison image; adjusting comparison image; and adjusting a bit width of binary values representative of the comparison image to generate the texture image.

Aspect 39. The method of any one of aspects 36 to 38, wherein generating the texture image comprises: downscaling the second image to generate a downscaled second image; upscaling the downscaled second image to generate an upscaled downscaled second image; comparing the second image to the upscaled downscaled second image to generate a first comparison image; downscaling the downscaled second image to generate a downscaled downscaled second image; upscaling the downscaled second image to generate an upscaled downscaled second image; comparing the downscaled second image to the upscaled downscaled second image to generate a second comparison image; upscaling the second comparison image to generate an upscaled second comparison image; and combining the first comparison image and the upscaled second comparison image to generate the texture image.

Aspect 40. The method of any one of aspects 36 to 39, wherein generating the texture image comprises: high-pass filtering the first image to generate a filtered first image; and comparing the filtered first image to the first image to generate the texture image.

Aspect 41. A non-transitory computer-readable storage medium having stored thereon instructions that, when executed by at least one processor, cause the at least one processor to perform operations according to any of aspects 21 to 40.

Aspect 42. An apparatus for providing virtual content for display, the apparatus comprising one or more means for perform operations according to any of aspects 21 to 40.

What is claimed is:

1. An apparatus for generating image data, the apparatus comprising:
at least one memory; and
at least one processor coupled to the at least one memory and configured to:
obtain a first image captured according to first image-capture settings;
determine second image-capture settings related to the first image-capture settings;
obtain a second image captured according to the second image-capture settings;
determine a mask indicative of pixels of the first image that are overexposed or underexposed;
adjust luma values of the pixels of the first image based on luma values of corresponding pixels of the second image; and
adjust chroma values of the pixels of the first image based on chroma values of the corresponding pixels of the second image.

2. The apparatus of claim 1, wherein the first image-capture settings comprise at least one of an auto-focus setting, an auto-exposure setting, or an auto-white-balance setting.

3. The apparatus of claim 1, wherein, to determine the second image-capture settings, the at least one processor is configured to determine that the pixels of the first image are overexposed and determine the second image-capture settings to decrease an exposure of the second image.

4. The apparatus of claim 1, wherein, to determine the second image-capture settings, the at least one processor is configured to determine that the pixels of the first image are underexposed and determine the second image-capture settings to increase an exposure of the second image.

5. The apparatus of claim 1, wherein, to determine the second image-capture settings, the at least one processor is configured to:
obtain a third image captured prior to the first image; and
determine the first image-capture settings and the second image-capture settings based on an exposure of the third image.

6. The apparatus of claim 1, wherein the second image has a lower resolution than the first image.

7. The apparatus of claim 1, wherein the at least one processor is configured to downscale the second image based on a scaling factor.

8. The apparatus of claim 1, wherein the at least one processor is configured to downscale the second image based on the mask.

9. The apparatus of claim 1, wherein the at least one processor is configured to write the corresponding pixels of the second image to a memory based on the mask.

10. The apparatus of claim 1, wherein, to adjust the luma values of the pixels of the first image, the at least one processor is configured to replace the luma values of the pixels of the first image with the luma values of corresponding pixels of the second image.

11. The apparatus of claim 1, wherein, to adjust the luma values of the pixels of the first image, the at least one processor is configured to blend the luma values of the pixels of the first image with the luma values of corresponding pixels of the second image.

12. The apparatus of claim 1, wherein the at least one processor is configured to determine for which of the pixels of the first image to adjust the chroma values based on a comparison between a saturation of the pixels of the first image and a saturation of the corresponding pixels of the second image.

13. The apparatus of claim 1, wherein, to adjust the chroma values of the pixels of the first image, the at least one processor is configured to replace the chroma values of the pixels of the first image with the chroma values of corresponding pixels of the second image.

14. The apparatus of claim 1, wherein, to adjust the chroma values of the pixels of the first image, the at least one processor is configured to blend the chroma values of the pixels of the first image with the chroma values of corresponding pixels of the second image.

15. The apparatus of claim 1, wherein the at least one processor is configured to:
determine third image-capture settings related to the first image-capture settings; and
obtain a third image captured according to the third image-capture settings;
wherein:
at least some pixels of the second image are underexposed;
at least some pixels of the third image are overexposed;
to determine the mask, the at least one processor is configured to determine underexposed pixels of the first image and determine overexposed pixels of the first image;
to adjust the luma values of the pixels of the first image, the at least one processor is configured to adjust the luma values of the overexposed pixels of the first image based on luma values of corresponding pixels of the second image; and
to adjust chroma values of the pixels of the first image, the at least one processor is configured to adjust the chroma values of the overexposed pixels of the first image based on chroma values of the corresponding pixels of the second image; and
the at least one processor is configured to:
adjust the luma values of the underexposed pixels of the first image based on luma values of corresponding pixels of the third image; and
adjust the chroma values of the underexposed pixels of the first image based on chroma values of the corresponding pixels of the third image.

16. The apparatus of claim 1, wherein the at least one processor is configured to:
downscale the second image to generate a downscaled second image;
write the downscaled second image to memory;
read the downscaled second image from the memory;
upscale the downscaled second image to generate a upscaled downscaled second image;
generate a texture image; and
modify the upscaled downscaled second image based on the texture image to generate a modified second image,
wherein:
the luma values of the pixels of the first image are adjusted based on luma values of corresponding pixels of the modified second image; and
the chroma values of the pixels of the first image are adjusted based on chroma values of the corresponding pixels of the modified second image.

17. The apparatus of claim 16, wherein, to generate the texture image, the at least one processor is configured to:
high-pass filter the second image to generate a filtered second image; and
compare the filtered second image to the second image to generate the texture image.

18. The apparatus of claim 16, wherein, to generate the texture image, the at least one processor is configured to:
high-pass filter the second image to generate a filtered second image;
compare the filtered second image to the second image to generate a comparison image;
adjust comparison image; and
adjust a bit width of binary values representative of the comparison image to generate the texture image.

19. The apparatus of claim 16, wherein, to generate the texture image, the at least one processor is configured to:
downscale the second image to generate a downscaled second image;
upscale the downscaled second image to generate an upscaled downscaled second image;
compare the second image to the upscaled downscaled second image to generate a first comparison image;
downscale the downscaled second image to generate a downscaled second image;
upscale the downscaled second image to generate an upscaled downscaled downscaled second image;
compare the downscaled second image to the upscaled downscaled second image to generate a second comparison image;
upscale the second comparison image to generate an upscaled second comparison image; and
combine the first comparison image and the upscaled second comparison image to generate the texture image.

20. The apparatus of claim 16, wherein, to generate the texture image, the at least one processor is configured to:
high-pass filter the first image to generate a filtered first image; and
compare the filtered first image to the first image to generate the texture image.
